(19) United States
(12) Patent Application Publication
(10) Pub. No.: US 2026/0338495 A1
(43) Pub. Date: Oct. 29, 2026

(54) TUBULAR MEMBRANE APPARATUS

(71) Applicant: Baltimore Aircoil Company, Inc., Jessup, MD (US)

(72) Inventors: Ellie M. Litwack, Columbia, MD (US); Gordon Massey, Dover, DE (US); Kevin Ellsworth Egolf, Hampstead, MD (US); Shawn Nelson, SR., Littlestown, PA (US); Eric Guy, Laurel, MD (US)

(21) Appl. No.: 19/103,721

(22) PCT Filed: Aug. 15, 2023
(86) PCT No.: PCT/US2023/030244

§ 371 Date: Feb. 13, 2025

Related U.S. Application Data
(60) Provisional application No. 63/398,456, filed on Aug. 16, 2022.

(51) Int. Cl. F28D 21/00; F28F 9/02

(52) U.S. Cl. CPC F28D 21/0015; F28F 9/0248; F28F 2265/26; F28F 2275/02

(57) ABSTRACT

In one aspect, a tubular membrane apparatus having an inlet header to receive a first fluid, an outlet header, and a plurality of elongate tubular membranes having interiors that permit the first fluid to flow from the inlet header to the outlet header. The tubular membranes have sidewalls configured to facilitate heat transfer and/or mass transfer between a second fluid contacting exterior surfaces of the sidewalls of the tubular membranes and the first fluid in the interiors of the tubular membranes. The tubular membranes are configured to lengthen in response to the interiors of the tubular membranes receiving the first fluid. The inlet header and the outlet header are movable relative to one another to increase a distance between the inlet header and the outlet header and compensate for the lengthening of the tubular membranes.

### CROSS-REFERENCE TO RELATED APPLICATION

This application claims benefit of U.S. Provisional Patent Application Number 63/398,456, filed Aug. 16, 2022, which is hereby incorporated herein by reference in its entirety.

### FIELD

This disclosure relates to tubular membrane apparatuses and, more specifically, to tubular membrane apparatuses having tubular membranes that facilitate heat and/or mass transfer between two fluids.

### BACKGROUND

Heat exchangers come in a wide variety of configurations and are used in a wide variety of applications. One type of heat exchanger is a tubular membrane heat exchanger. Tubular membrane heat exchangers have tubes through which a working fluid is directed. Another fluid, such as air, is directed over the exterior of the tubes. The sidewalls of the tubes permit heat transfer and/or mass transfer between the working fluid in the tubes and the fluid traveling across the exterior surfaces of the tubes. Tubular membranes may be difficult to connect to headers due to the small diameters of the tubes, the large quantity of tubes of the tubular membrane, and the material of the tubular membranes. For example, dense ion exchange membranes may be soft and deform during handling of the membranes. Another difficulty with some tubular membranes is that the tubular membranes lengthen when wet. The elongation of the tubular membranes may cause twisting and kinking of the tubular membranes, which inhibits the flow of working fluid through the tubular membranes.

### BRIEF DESCRIPTION OF THE DRAWINGS

FIG. 1A is a schematic view of a heat exchanger system including tubular membrane heat exchangers;

FIG. 1B is a perspective, partial cross-sectional view of a cooling tower having tubular membrane heat exchangers including stacked upper and lower tubular membrane heat exchangers;

FIG. 1C is an elevational view of a connection between an inlet manifold and an upper tubular membrane heat exchanger of the cooling tower of FIG. 1B;

FIG. 1D is a perspective, cross-sectional view of a connection between upper and lower tubular membrane heat exchangers of the cooling tower of FIG. 1B;

FIG. 1E is a cross-sectional view of a tubular membrane, a fitting, and a header plate of a tubular membrane heat exchanger assembled and having potting applied to opposite sides of the header plate portion;

FIG. 1F is a cross-sectional view of a tubular membrane, a header plate portion of a tubular membrane heat exchanger assembled and having potting applied to opposite sides of the header plate portion;

FIG. 2A is a schematic view of a tubular membrane heat exchanger where the tubular membranes are wet;

FIG. 2B is a schematic view of the tubular membrane heat exchanger of FIG. 2A where the tubes are dry;

FIG. 3A is a cross-sectional view of a sleeve for tubular membranes, the sleeve in an initial configuration;

FIG. 3B is a cross-sectional view of the sleeve of FIG. 3A in a contracted configuration;

FIG. 4A is a schematic view of a tubular membrane heat exchanger having a movable header supported by compression springs;

FIG. 4B is a schematic view of a tubular membrane heat exchanger having a movable header supported by tension springs;

FIG. 4C is a schematic view of a tubular membrane heat exchanger having a movable header supported by a fluid;

FIG. 5A-5B are side elevation and front elevation schematic views, respectively, of a tubular membrane heat exchanger having a movable header supported by torsion springs;

FIG. 6 is a front elevation schematic view of a tubular membrane heat exchanger having a movable header supported by a resilient conduit;

FIG. 7A is a perspective of a tubular membrane having supporting material along the length of the tubular membrane;

FIG. 7B is a side schematic view illustrating a process of applying the supporting material to the sidewall of the tubular membrane of FIG. 7A;

FIG. 8A is a schematic view of a tubular membrane heat exchanger having a tubular membrane attached to a spacer;

FIG. SB is a perspective view of tubular membranes extending through spacers;

FIG. 8C is a perspective view of one of the spacers of FIG. 8B;

FIG. 9 is a schematic view of a tubular membrane heat exchanger assembly having wires extending through tubular membranes of the assembly;

FIG. 10A is a schematic view of a nozzle of a system used to form the tubular membranes of FIG. 9 about the wires;

FIG. 10B is schematic view of the system for forming the tubular membranes of FIG. 9;

FIGS. 11A, 11B, and 11C are schematic views illustrating a process for applying supporting material to end portions of tubular membranes;

FIG. 12 is a schematic view of a tubular membrane with lengths of supporting material secured to the tubular membrane;

FIG. 13A is a top plan view of a comb spacer for supporting tubular membranes of a tubular membrane heat exchanger, the comb spacer shown in a disassembled configuration;

FIG. 13B is a side elevational view of the comb spacer of FIG. 13A in the disassembled configuration;

FIG. 13C is a top plan view of the comb spacer assembly of FIG. 13A, the comb spacer assembly in an assembled configuration;

FIG. 13D is a perspective view the comb spacer of FIG. 13A being assembled with tubular membranes; FIG. 14A is a perspective view of a comb spacer according to another embodiment in a disassembled configuration;

FIG. 14B is a perspective view of the comb spacer of FIG. 14A in an assembled configuration with tubular membranes extending through openings formed by the connected comb spacers;

FIG. 15 is a front elevational view of a comb spacer according to another embodiment;

FIG. 16A is a perspective view of a tubular membrane heat exchanger having comb headers;

FIG. 16B is an exploded, perspective view of a comb header of the tubular membrane heat exchanger of FIG. 16A;

FIGS. 17A and 17B are schematic, cross-sectional views illustrating a process for forming a header of a tubular membrane heat exchanger;

FIG. 17C is a plan view of a header formed according to the process of FIGS. 17A and 17B;

FIGS. 18A, 18B, 18C, and 18D are schematic, cross-sectional views illustrating another process for forming a header of a tubular membrane heat exchanger; and

FIG. 19 is a perspective view of a header with tubular membranes connected thereto.

### DETAILED DESCRIPTION

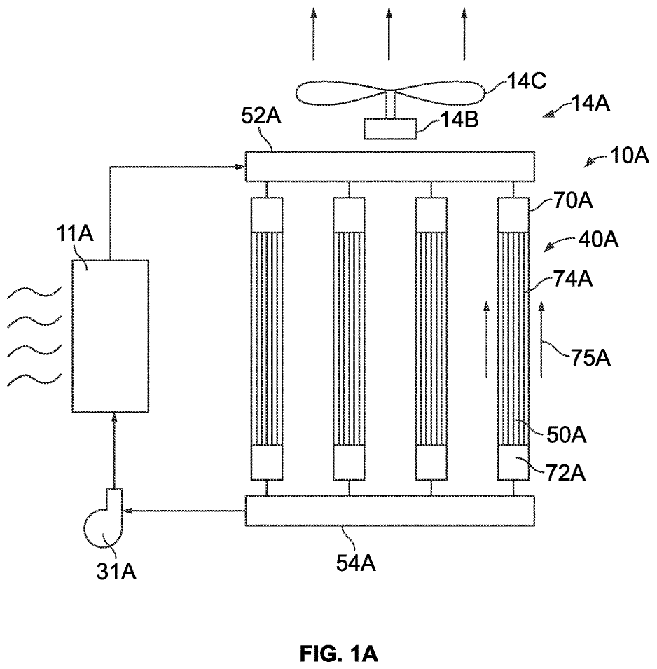

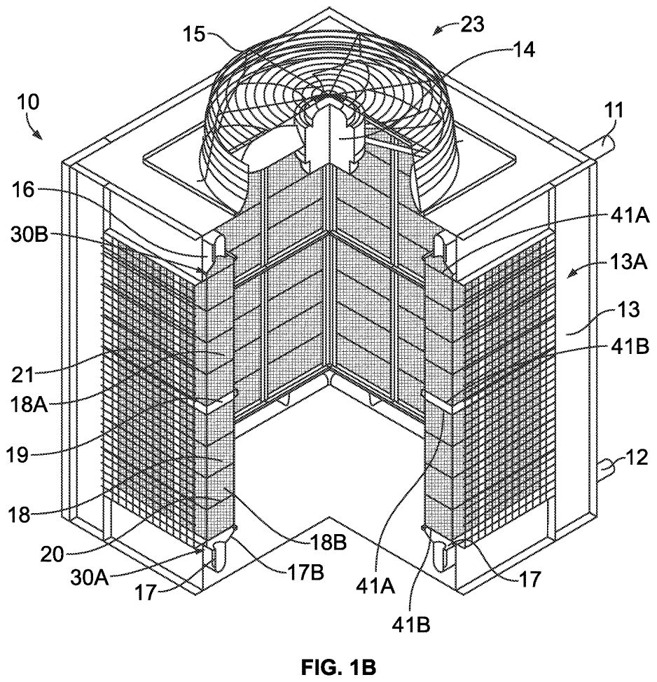

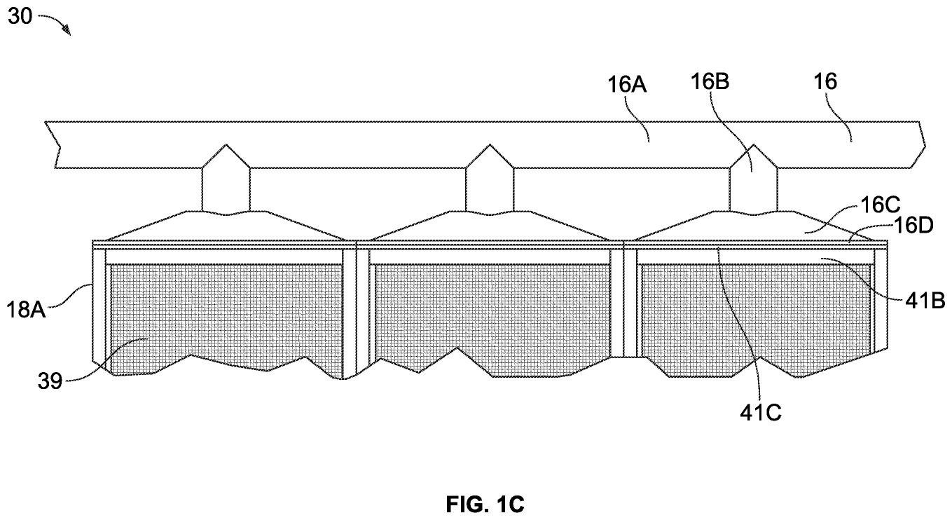

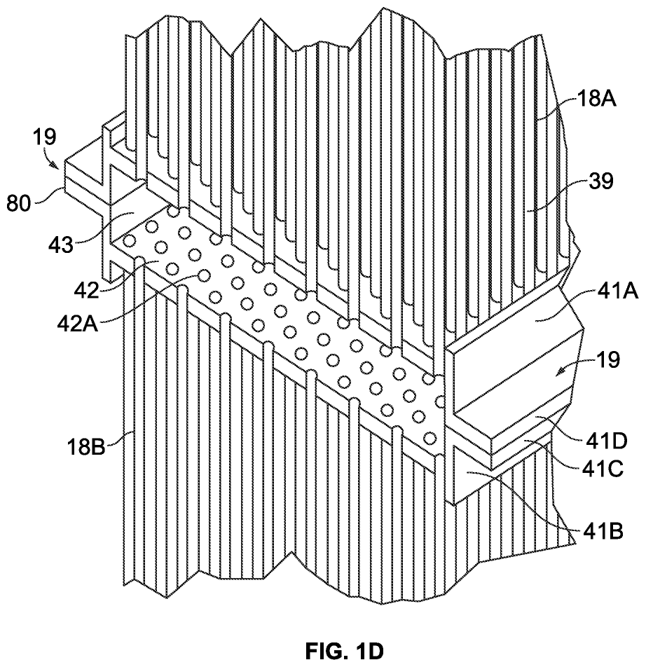

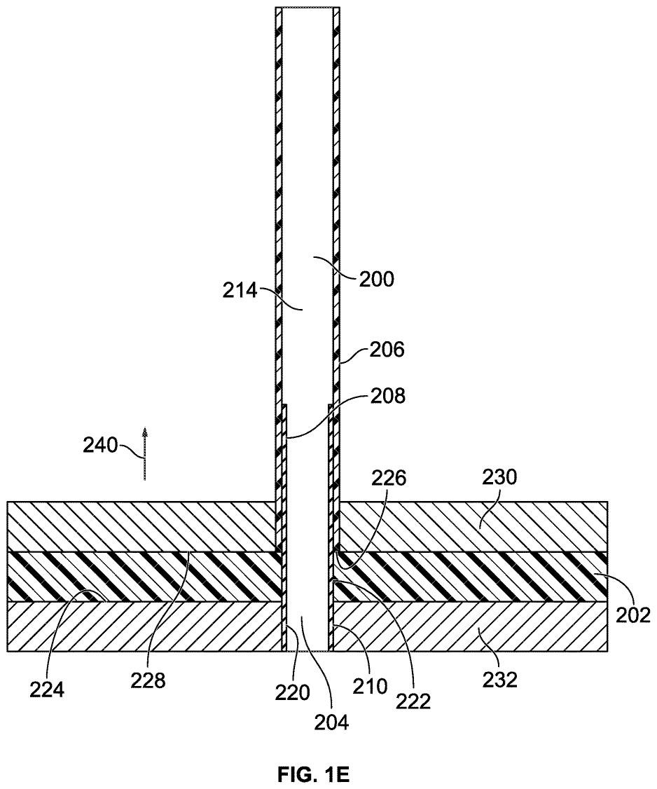

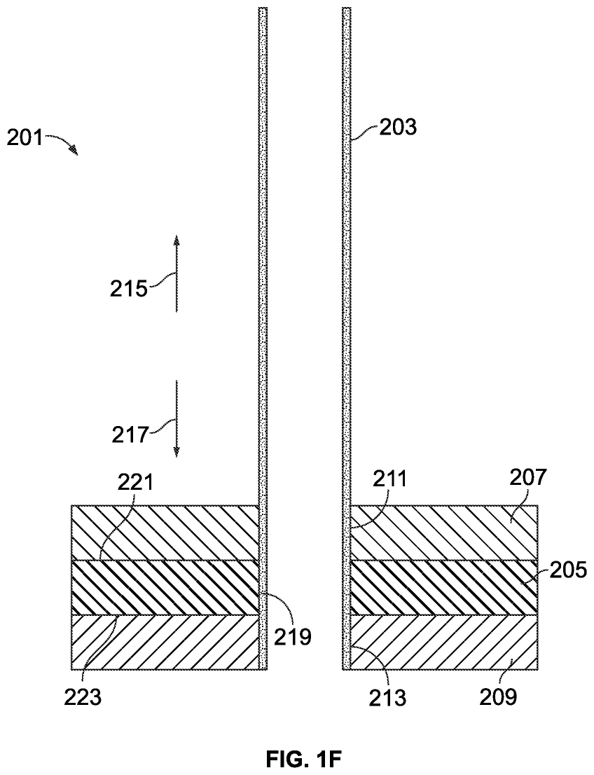

Regarding FIG. 1A, a heat exchanger system 10A is provided that includes a heat exchanger 11A which receives heat, such as heat from inside of a building or an industrial process, and transfers the heat to a working fluid such as water or a water/glycol mixture. The fluid may include liquid and gas, the proportions of which may vary as the working fluid travels throughout the heat exchanger system 10A. The heat exchanger system 10A includes a pump 31A configured to pump the fluid from the heat exchanger 11A to a heat exchange apparatus such as a cooling tower 40A. The cooling tower 40A includes one or more tubular membrane apparatuses such as heat exchanger cassettes. Example heat exchanger cassettes are tubular membrane heat exchangers 50A shown in FIG. 1A. The tubular membrane heat exchangers 50A are releasably or permanently connected to an inlet manifold 52A and an outlet manifold 54A. In another approach, the cooling tower 40A may receive heat and transfer the heat to the working fluid, while the heat exchanger 11A removes heat from the working fluid.

Each tubular membrane heat exchanger 50A includes an upper header or inlet header 70A that receives the fluid from the inlet manifold 52A, one or more tubular membranes 74A through which the fluid travels, and a lower header or outlet header 72A that collects the fluid from the tubular membranes 74A. The tubular membrane heat exchangers 50A may include one or more of the tubular membrane heat exchanger assemblies described below.

Referring to FIG. 1A, the tubular membranes 74A facilitate heat and/or mass transfer between a first fluid within the tubular membranes 74A and a second fluid outside of the tubular membranes 74A. As one example, the tubular membranes 74A may be made of a gas-permeable material that is also liquid-impermeable at the range of operating pressures of the tubular membrane heat exchanger 50A. The tubular membranes 74A receive fluid including a mixture of liquid and gas that has been heated by the heat exchanger 11A. The tubular membranes 74A permit the gas, such as vapor, that has been heated by the heat exchanger 11A to travel out of the tubular membranes 74A. As an example, the fluid entering the tubular membranes 74A may be a mixture of water and gaseous water vapor. The liquid traveling through the tubular membranes 74A is cooled by indirect cooling from the airflow over the exterior surfaces of the tubular membranes 74 and the release of higher-energy water vapor through the tubular membrane 74A.

In another embodiment, the tubular membrane heat exchangers 50A utilize pervaporation to transfer heat between a first fluid within the tubular membranes 74A and a second fluid outside of the tubular membranes 74A. For example, the tubular membrane heat exchanger 50A receives heated liquid (such as water) from the heat exchanger 11A. Molecules of the heated liquid (e.g., H₂O) are absorbed by the tubular membranes 74A. The molecules of the liquid absorbed by the tubular membranes 74A diffuse from inner surfaces of the tubular membranes 74A to outer surfaces of the tubular membranes 74A. The molecules of the liquid that have diffused to the outer surfaces of the tubular membranes 74A are desorbed into the exterior fluid (e.g., air) and remove heat from the tubular membranes 74A. In the context of liquid water entering the tubular membrane heat exchanger 50A and ambient air being directed across the exterior surfaces of the tubular membranes, the diffused water molecules on the exterior of the tubular membranes 74A evaporate into the ambient air stream. In other embodiments, molecules of a fluid outside of the tubular membranes may diffuse into the interior of the tubular membranes.

In one approach, the fluid may be completely gas upon reaching the tubular membranes 74A, a portion of the gas stream permeates through the tubular membranes 74 into the ambient, and the remaining gas of the gas stream exits the outlet header 72A as cooled gas, a gas/liquid mixture, or as liquid.

The tubular membranes 74A may include, for example, one or more polymers such as polypropylene (PP), polydimethylsiloxane (PDMS) or polytetrafluoroethylene (PTFE). As another example, the tubular membranes 74A may be a microporous hydrophobic polysulfone material. In some approaches, the tubular membranes 74A may be made of ceramic materials. Another material that may be utilized for the tubular membranes 74A includes graphene oxide membranes.

In one embodiment, the tubular membranes described herein may include a porous substrate layer and a membrane layer. The membrane layer may be an artificial or synthetic membrane. Examples of synthetic membranes that may be used include polymeric membranes, polymer electrolyte membranes, ceramic membranes, and graphene oxide membranes.

The tubular membranes 74A permit controlled diffusion of fluid molecules through the side walls of the tubular membranes 74A while inhibiting drift, such as bacteria, chemicals, and debris, from traveling through the side walls of the tubular membranes 74A. The tubular membranes 74A thereby operate as a barrier to Legionella and other microbes from passing between the fluid inside of the tubular membranes and the fluid outside of the tubular membranes.

The tubular membranes 74A may be porous and have openings or pores to facilitate heat and/or mass transfer. The pores may have sizes in a range of 10 angstroms to 35 micrometers. For example, the pores may be in the range of 1 nanometer to 20 nanometers. In one embodiment, the tubular membranes 74A have pore sizes that are less than 0.001 micrometers. In another embodiment, the tubular membranes 74A have pore sizes less than 1 micrometer and greater than 0.001 micrometer.

The tubular membranes 74A may be flexible and relatively flimsy which makes securing the tubular membranes 74A to another component difficult. For example, the tubular membranes 74A may be stiff enough to be placed vertically on a surface and retain their shape, but any external pressure makes the tubular membranes 74A bend and/or twist. The tubular membranes 74A may be made of, or coated with, a material having UV resistance to inhibit algae growth and/or biocidal properties to inhibit bacteria growth.

The material of the tubular membranes 74A may be porous or dense. For example, the tubular membranes 74A may be hydrophobic porous membranes wherein water vapor transport to the exterior of the tubular membranes 74A occurs primarily by diffusion through pores of the tubular membranes 74A. The permeability of the tubular membranes may be affected by the pore size, total porosity, surface porosity, and pore tortuosity of the tubular membranes. As an example, the pore size may be in the micrometer range. For dense membrane materials, water vapor transport happens by solution-diffusion through the polymer layer itself since no pores are present in the dense membrane material.

The tubular membranes 74A may be made of homogenous membranes having a single layer that is impermeable to liquid but highly permeable for vapors. In other embodiments, the tubular membranes 74A may have a composite form including a dense skin layer and a porous support layer that are vapor permeable. The dense skin layer may be impermeable to liquid at the operating conditions (e.g., the range of operating pressures) of the tubular membrane heat exchanger 50A. The support layer provides mechanical stability to the membrane while the dense skin layer is responsible for selectivity.

Regarding FIG. 1A, the cooling tower 40A includes an airflow generator such as one or more fans 14A. In one embodiment, each fan 14A includes fan blades 14C and a motor 14B. In another embodiment, the one or more fans 14A may include a plurality of fans sharing a common motor. The fan 14A is configured to generate airflow relative to the tubular membranes 74A, such as in an upward direction 75A along the lengths of the tubular membranes 74A, in a downward direction (opposite direction 75A) along the lengths of the tubular membranes 74A, and/or in one or more directions transverse to the lengths of the tubular membranes 74A such as perpendicular to the lengths of the tubular membranes 74A. The airflow may assist in removing the gas from outer surfaces of the tubular membranes 74A. The fluid may be water, as mentioned above, and pure water vapor may permeate through the tubular membranes 74A while contaminants such as debris, solids dissolved or undissolved in the water, scale, and organisms remain inside of the tubular membranes 74A. Further, the tubular membranes 74A inhibit exterior contaminants from entering the interior of the tubular membranes 74A.

Regarding FIG. 1B, a cooling tower 10 is provided that is similar in many respects to the cooling tower 40A discussed with respect to FIG. 1A above. The cooling tower 10 includes a working fluid inlet 11, a working fluid outlet 12, an outer structure such as a tower structure 13, a fan 14, and optionally a fan guard 15. The fan 14 is operable to draw air in through air inlets 13A of the cooling tower 10. The working fluid received at working fluid inlet 11 is directed to an inlet manifold 16 that provides the working fluid to one or more tubular membrane heat exchanger cassettes, such as tubular membrane heat exchangers 18. The tubular membrane heat exchange modules 18 are similar to the tubular membrane heat exchange modules 50A discussed above. Further, in other embodiments of the cooling tower 10 the tubular membrane heat exchange modules 18 are replaced with one or more of the tubular membrane heat exchanger assemblies discussed below.

As shown in FIG. 1B, each tubular membrane heat exchanger 18 includes headers, such as upper header 41B and lower header 41A, and tubular membranes 39 that are similar to the tubular membranes 74A discussed above. The tubular membrane heat exchangers 18 include pairs of vertically stacked upper and lower tubular membrane heat exchangers 18A, 18B configured to cool the working fluid as the working fluid flows through the upper and lower tubular membrane heat exchangers 18A, 18B. The cooling tower 10 has an outlet manifold 17 that collects the working fluid from the pairs of vertically stacked upper and lower tubular membrane heat exchangers 18A, 18B and directs the working fluid to the working fluid outlet 12.

The cooling tower 10 includes releasable connections 30A, 30B between the upper and lower tubular membrane heat exchangers 18A, 18B and the inlet and outlet manifolds 16, 17. The cooling tower 10 includes connections 19 between each pair of upper and lower tubular membrane heat exchangers 18A, 18B that permit working fluid to flow from the upper tubular membrane heat exchanger 18A to the lower tubular membrane heat exchanger 18B.

The upper and lower tubular membrane heat exchangers 18A, 18B of each pair are thereby connected in series. Further, each pair of upper and lower tubular membrane heat exchange modules 18A, 18B are connected to the inlet and outlet manifolds 16, 17 in parallel with the other pairs of upper and lower tubular membrane heat exchange modules 18A, 18B. The modular nature of the upper and lower tubular membrane heat exchangers 18A, 18B facilitates straightforward and efficient servicing of the cooling tower 10. For example, if one of the upper tubular membrane heat exchangers 18A needs to be replaced, the upper tubular membrane heat exchanger 18A is disconnected from the inlet manifold 16, disconnected from the associated lower tubular membrane heat exchanger 18B, and removed. A replacement upper tubular membrane heat exchanger 18A is then connected to the inlet manifold 16 and the lower tubular membrane heat exchanger 18B. Alternatively, if a pair of upper and lower tubular membrane heat exchangers 18A, 18B needs to be replaced, the pair is disconnected from the inlet and outlet manifolds 16, 17, the pair is removed from the cooling tower 10, and a new pair of upper and lower tubular membrane heat exchangers 18A, 18B are connected to the inlet and outlet manifolds 16, 17. For larger heat exchange apparatus embodiments, valving may be provided before and after each tubular membrane heat exchanger 18 such that each module 18 may be serviced and/or replaced without draining the entire system. Further, providing valving before and after each tubular membrane heat exchanger 18 may permit other components of the cooling tower to be operation while the service is performed.

The cooling tower 10 has protectors, such as screens 21, to protect the tubular membrane heat exchangers 18 from dirt, debris, sunlight, and/or impact. The cooling tower 10 has an induced-draft configuration and includes a fan 14 operable to draw air into the air inlets 13A, across the tubular membranes 39 of the tubular membrane heat exchangers 18, and out through an air outlet 23 of the cooling tower 10. It has been found that inducing airflow relative to the tubular membranes 39 creates a slight air vacuum at the exterior of the tubular membranes 39. The slight air vacuum at the exterior of the tubular membranes 39 assists the egress of gas from the tubular membranes 39 and increases efficiency of operation of the tubular membranes 39. However, it is noted that induced draft, forced draft in upflow or downflow, and crossflow airflow patterns are all within the scope of the present disclosure.

The tubular membrane heat exchangers 18 facilitate heat transfer from the working fluid at low working fluid pressures. For example, the cooling tower 10 may utilize a working fluid at low pressure, such as less than 25 psi. In another embodiment, the cooling tower 10 may be operable in an “open” configuration wherein the working fluid is exposed to atmospheric air pressure. In this embodiment, the fluid in the tubular membrane heat exchangers 18 may be in fluid communication with atmospheric air to ensure the fluid is at ambient pressure while limiting the transmission of drift and other contaminants from the fluid to the air. For example, the fluid in the tubular membrane heat exchangers 18 may be in fluid communication with atmospheric air via a small opening and/or the fluid may be shielded from moving air of the tubular membrane heat exchanger 18 to limit exposure of the working fluid to air moving through the tubular membrane heat exchanger 18. In another embodiment, the cooling tower 10 may operate at higher pressures, such as around 150 psi, or greater than 200 psi. In embodiments where the tubular membranes 39 conduct refrigerant, the cooling tower 10 may operate with an internal pressure of up to 450 psi.

FIG. 1C shows a more detailed view of the cooling tower 10 including the releasable connections 30 between the inlet manifold 16 and the upper tubular membrane heat exchangers 18A. More specifically, the inlet manifold 16 includes a primary tube 16A with branch tubes 16B diverging therefrom. The inlet manifold 16 further includes a distributor such as a distribution header 16C each having a flange 16D that is secured to a flange 41C of the inlet header 41B of the upper tubular membrane heat exchanger 18. The distribution header 16C may have a shape resembling a square pyramidal frustum and optionally includes a deflector configured to distribute working fluid entering the distribution header 16C to the tubular membranes 39 of the upper header portion 41B, The flanges 16D, 41C may be releasably secured to one another, such as by one or more fasteners. In one embodiment, a sealing element such as a gasket is provided between the flanges 16D, 41C. To connect the upper tubular membrane heat exchanger 18A to the inlet manifold 16, a user positions the inlet header 41B below the distribution header 16C and secures the flanges 16D, 41C thereof using fasteners or other approaches. In another embodiment, the connections 30 are permanent.

Regarding FIG. 1D, the connection 19 between the upper and lower tubular membrane heat exchangers 18A, 18B includes flanges 41C, 41D of header bodies 80 of the lower and upper headers 41A, 41B. The flanges 41C, 41D are permanently or releasably secured together. When connected, the lower and upper headers 41A, 41B form a wetted compartment 43 that receives working fluid from the tubular membranes of the upper tubular membrane heat exchanger 18A and directs the working fluid into the tubular membranes 39 of the lower tubular membrane heat exchanger 18B.

The wetted compartment 43 formed between the tubular membrane heat exchangers 18 permits tubular membrane heat exchangers 18 to be connected together to form a longer heat exchanger. The connected tubular membrane heat exchangers 18 may form a longer heat exchanger without the need for additional headers and associated piping. The wetted compartment 43 may be taller than shown to promote fluid mixing or shorter than shown to provide a more compact connection. In one embodiment, the wetted compartment 43 includes fluid mixers, such as stationary or movable members, within the wetted compartment 43.

In one embodiment, the connection 19 includes one or more fasteners such as assemblies of bolts, nuts, and washers, configured to releasably secure the flanges 41C, 41D together. As other examples, the flanges 41C, 41D may be joined together using a bonding agent, welded together, or connected together with mating portions of the lower and upper headers 41A, 41B. The connection 19 may include a sealing element, such as a gasket, and/or a bonding agent such as epoxy.

The header body 80 of each tubular membrane heat exchanger 18 includes a header plate portion 42 have a plurality of apertures that receive ends of the tubular membranes 39 to attach the tubular membranes 39 to the upper and lower headers 41B, 41A. In some forms, the upper and lower headers 41B, 41A may include potting about the tubular membranes to secure the tubular membranes 39 to the upper and lower headers 41B, 41A. Regarding FIG. 1B, the connections 30A between the lower tubular membrane heat exchanger 18B and the outlet manifold 17 that may be identical to the connections 30 between the inlet manifold 16 and the upper tubular membrane heat exchanger 18A. The outlet manifold 17 includes collection headers 17B similar to the distribution header 16C discussed above with respect to FIG. 1C. The collection headers 17B have flanges configured to be releasably or permanently secured to the flange 41D of the lower header 41A of the lower tubular membrane heat exchanger 18B.

In one approach, the tubular membrane heat exchangers 18 are bidirectional, meaning that the tubular membrane heat exchangers 18 may be installed with either the inlet header 41B in an upper position or the outlet header 41A in the upper position. Further, the inlet and outlet manifolds 16, 17 may each function as an inlet manifold or an outlet manifold depending on the direction of flow of the working fluid. For example, the working fluid flow may be reversed in some applications such that the working fluid travels from the manifold 17, through the tubular membrane heat exchangers 18, and into the manifold 16. In other embodiments, the tubular membrane heat exchangers 18 may be unidirectional.

In some embodiments, the tubular membrane heat exchanger includes tubular membranes attached to the header via fittings 204. Regarding FIG. 1E, a tubular membrane 200 (similar to tubular membranes 74A discussed above) is connected to a header plate portion 202 of a header similar to the outlet and inlet headers 41A, 41B via the fitting 204. The fitting 204 has an end portion 208 that is sized to tightly fit into an end portion 206 of the tubular membrane 200. In one embodiment, the fitting 204 is a tube having an annular side wall 210 and a cylindrical outer surface that engages a surface of an opening 222 of the header plate portion 202. The cylindrical outer surface of the fitting 204 has an outer diameter that is sized to form a tight fit between the fitting 204 and the surface forming the opening 222 of the plate portion 202 which inhibits liquid potting from seeping between the fitting 204 and the plate portion 202 when the potting is poured onto the plate portion 202. Further, the outer diameter of outer surface of the fitting 204 may be within ±1% of an inner diameter of the tubular membrane 200. The tubular membrane 200 and fitting 204 may be configured to form a fluid-tight seal therebetween and the potting 230 reinforces the fluid-tight seal to resist pressurized fluid. In other embodiments, the tubular membrane 200 and fitting 204 may form a fluid-tight seal therebetween after the potting 230 has cured.

In some embodiments, the tubular membrane heat exchanger includes tubular membranes attached to the header without fittings. Regarding FIG. 1F, a tubular membrane assembly 201 is provided having a tubular membrane 203, a header plate 205, outer potting 207, and inner potting 209. The outer potting 207 bonds to an outer portion 211 of the tubular membrane 203, the inner potting 209 bonds to an inner portion 213 of the tubular membrane 203, and both outer and inner potting 207, 209 bond to the header plate 205. In this manner, the outer and inner potting 207, 209 anchor the tubular membrane 203 to the header plate 205 on opposite sides of the header plate 205 and resist movement of the tubular membrane 203 in directions 215, 217. During assembly of the tubular membrane assembly 201, the tubular membrane 203 is advanced through an opening 219 of the header plate 205 and liquid potting is applied to outer and inner surfaces 221, 223 of the header plate 205.

The tubular membrane 200 is connected to the header plate portion 202 by advancing the end portion 208 of the fitting 204 into a lumen 214 of the tubular membrane 200. The fitting 204 may engage the tubular membrane 200 and form a fluid-tight connection therebetween. The connection may further include advancing an opposite end portion 220 of the fitting 204 into an opening 222 of the header plate portion 202. The end portion 220 of the fitting 204 is advanced so that the end portion 220 protrudes outward from a surface 224 of the header plate portion 202. The tubular membrane 200 has an end 226 that is positioned against or near an opposite surface 228 of the header plate portion 202.

To maintain the seal between the tubular membrane 200 and fitting 204 upon the tubular membrane 200 receiving pressurized fluid, potting 230 is applied to the surface 228 of the header plate portion 202 and into contact with the tubular membrane 200. Potting 232 is also applied to the surface 224 of the header plate portion 202. The potting 232 connects to the end portion 220 of the fitting 204 to resist pull-through of the fitting 204 in direction 240. The potting 230, 232 may be made of the same or different potting materials. The potting 230, 232 may each have a depth in the range of 0.1 inches to 2 inches, such as approximately 0.25 inches or less. In one embodiment, the fitting 204 includes a thin-walled stainless steel tube.

As discussed above, the tubular membranes 74A are flexible and relatively flimsy tubes that are prone to bending and kinking. This not only makes it difficult to assemble the tubular membrane heat exchangers modules 50A, but sharp bending or kinking of the tubular membranes 74A may restrict the flow of fluid therethrough. Sharp bending or kinking of tubular membranes 74A may also cause the tubular membranes 74A to tear and/or cause the tubular membranes 74A to leak. Moreover, when the tubular membranes 74A are wet, for example, when working fluid flows through the tubular membranes 74A, the length of the tubes increases which may further cause the tubular membranes 74A to bend or kink.

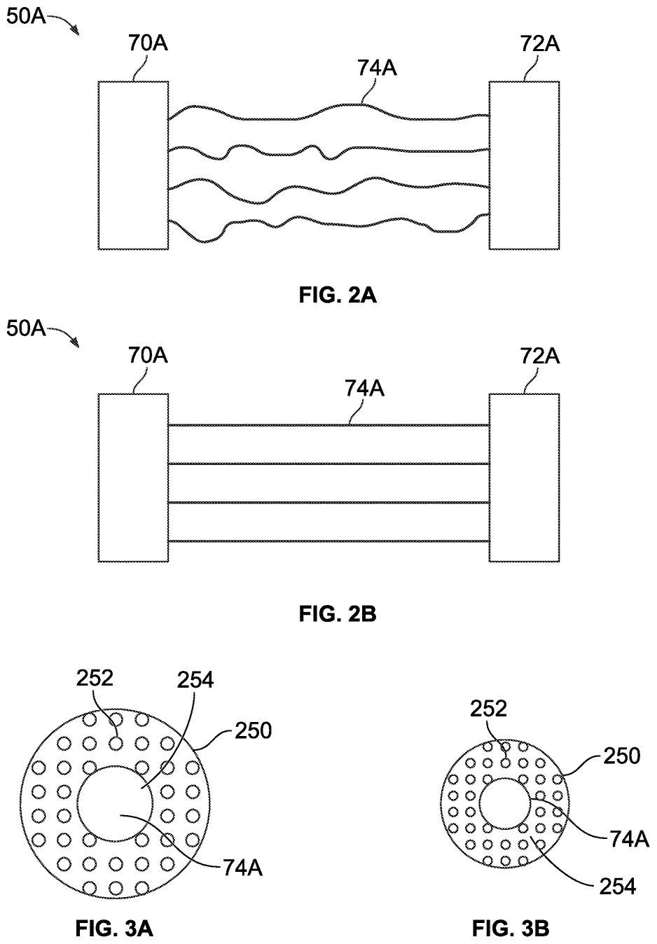

With respect to FIG. 2A and 2B, to reduce the kinking or bending of the tubular membranes 74A of tubular membrane heat exchanger 50A, the distance between the headers 70A, 72A may be set when the tubular membranes 74A are in their elongated, wet configuration. In FIG. 2A, the ends of the tubular membranes 74A are secured to the headers 70A, 72A and the tubular membranes 74A are in their wet configuration. The inlet header 70A and the outlet header 72A are shifted apart to pull the tubular membranes 74A substantially straight or until the tubular membranes have an acceptable amount of slack or bending. The inlet header 70A and outlet header 72A may be shifted apart by moving one of the inlet header 70A and the outlet header 72A away from the other of the inlet header 70A and outlet header 72, or moving both of the inlet header 70A and outlet header 72A away from each other. The distance between the inlet header 70A and outlet header 72A may then be fixed with the tubular membranes in the wet, elongated configuration. For example, a support (e.g., a strut of a cooling tower) may be attached to the inlet header 70A and outlet header 72A to fix the distance between the headers 70A, 72A.

The distance between the inlet and outlet headers 70A, 72A is selected such that the tubular membranes 74A are generally straight, avoid contact with one another, and/or are not kinked when the inlet and outlet headers 70A, 72A are fixed relative to one another. In this manner, when working fluid (e.g., liquid water and water vapor) subsequently wets the tubular membranes 74A during operation of the cooling tower 40A, the tubular membranes 74A have a preload or pretension that inhibits excessive lateral movement and kinking of the tubular membranes 74A.

With respect to FIG. 2B, the tubular membrane heat exchanger 50A is shown with the tubular membranes 74A in the dry configuration after the distance between the headers 70A, 72A has been fixed. As the tubular membranes 74A dry, the tubular membranes 74A begin to contract. The shortening of the tubular membranes 74A removes or reduces any bends in the tubular membranes 74A. In some forms, as the tubular membranes 74A dry, they are pulled taut between the fixed headers 70A, 72A. When setting the distance between the headers 70A, 72A with the tubular membranes 74A in their wet configuration, the tubular membranes 74A may be given some slack or permitted to bend slightly so that as the tubular membranes 74A contract they are not pulled so taut that the tubular membranes 74A tear or pull out of the headers 70A, 72A. Once the distance between the headers 70A, 72A has been fixed, the tubular membrane heat exchanger 50A may be transported and/or installed in a heat exchanger with the tubular membranes 74A in the dry configuration where the tubular membranes are substantially straight and, for example, there is little risk of the tubular membranes tangling. In one embodiment, the tubular heat exchange module 50A includes a frame having one or more rigid structural members and the inlet and outlet headers 70A, 72A are secured to the frame. The frame maintains the fixed distance between the inlet and outlet headers 70A, 72A.

With respect to FIGS. 3A and 3B, the tubular membrane heat exchange exchangers may include sleeves 250 on the outsides of the tubular membranes 74A. Each sleeve 250 may be more rigid than the associated tubular membrane 74A and support the tubular membrane 74A from bending and/or kinking. The sleeve 250 may be a shrink tubing that contracts upon the application of a stimulus such as heat, chemicals, and/or electrical current. Regarding FIG. 3A, the sleeve 250 is in an expanded state. The sleeve 250 includes a sidewall 252 extending about an opening 254. The sidewall 252 may be formed of a braided or woven material with openings that permit airflow through the sidewall 252 of the sleeves 250. As an example, the sleeve 250 may be formed of polyolefin. As another example, the sleeve 250 may be formed of polyolefin and a supporting material such as polyester. As another example, the sleeve 250 may be formed of a copolymer of polyolefin and another polymer such as polyester. As another example, the sleeve 250 may be formed of a fabric comprised of polyolefin fiber or polyolefin copolymer fiber and a supporting fiber such as a polyester fiber and/or nylon fiber. When the sleeve 250 is in the expanded state, the inner diameter of the opening 254 is larger than the outer diameter of the tubular membrane 74A, which allows the tubular membrane 74A to be advanced into the opening 254 and through the sleeve 250.

With the tubular membrane 74A extending in the opening 254 of the sleeve 250, the stimulus may be applied to the sleeve 250 to cause the sleeve 250 to transition to a contracted state (see FIG. 3B). For example, where the sleeve 250 is a heat shrink material, heat may be applied to the sleeve 250 to cause the sleeve 250 to contract about the tubular membrane 74A. When the sleeve 250 is in the contracted state, the inner diameter of the opening 254 is smaller than the inner diameter of the opening 254 in the expanded state. The inner diameter of the opening 254 of the sleeve 250 in the contracted state may be the sized to firmly engage the outer diameter of the tubular membrane 74A. The sleeve 250 may thereby contract about the tubular membrane 74A and be secured to the tubular membrane by a friction fit. The sidewall 252 of the sleeve 250 may be more rigid in the contracted state than in the expanded state and aid to keep the tubular membrane 74A substantially straight and resist bending and/or kinking. The sleeve 250 may include a mesh or lattice of fibers as some examples.

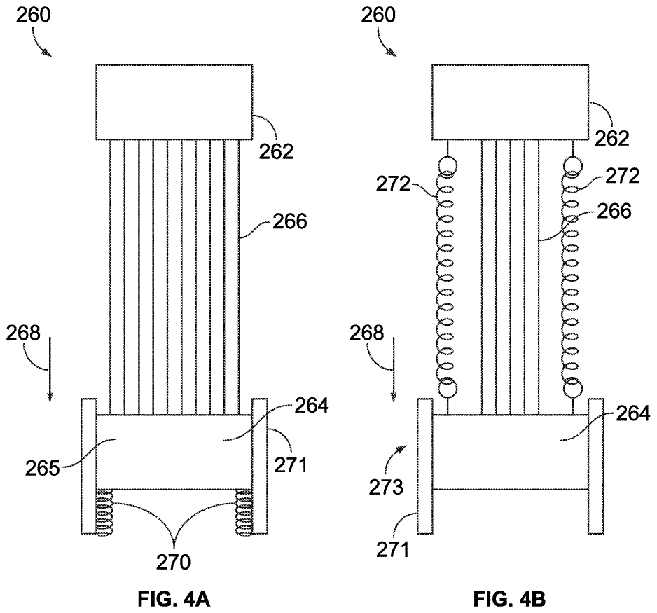

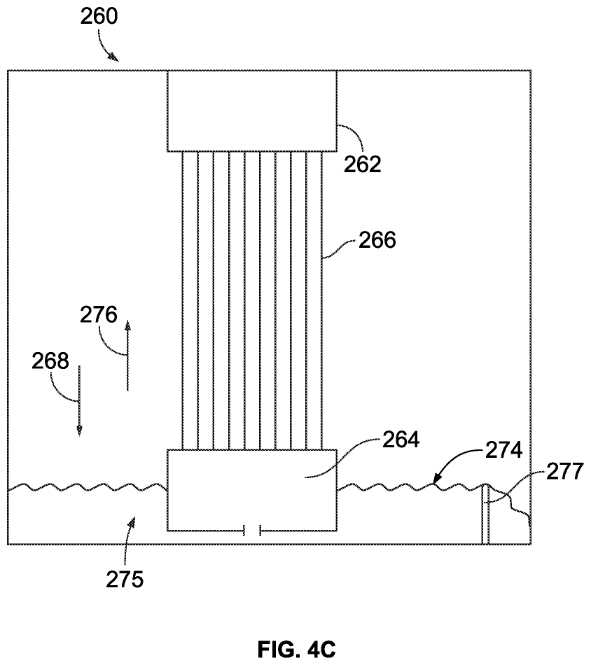

With respect to FIG. 4A, a tubular membrane heat exchanger 260 is provided is similar in many respects to the tubular membrane heat exchangers 18, 50A discussed above. The tubular membrane heat exchanger 260 includes a stationary or fixed inlet header 262 and a movable outlet header 264. Although the following discussion refers to the outlet header 264 as moving relative to the inlet header 262, it will be appreciated that in other embodiments the inlet header 262 may move relative to a fixed outlet header 264. Further, both the inlet header 262 and the outlet header 264 may be movable in some embodiments.

The inlet header 262 may be fixed relative to a structure of the cooling tower 10, for example, by fasteners, and inhibited from moving substantially relative to the structure. The outlet header 264 may be moved relative to the inlet header 262, for example, as the tubular membranes 266 lengthen and shorten as the tubular membranes 266 are wetted and dry out. The outlet header 264 may be suspended from the inlet header 262 by the tubular membranes 266. As the tubular membranes 266 lengthen as they are wetted (e.g., due to working fluid flowing therethrough), the outlet header 264 moves downward in the direction 268 away from the inlet header 262 due to gravity acting on the outlet header 264. The movement of the outlet header 264 downwardly, away from the inlet header 262 takes up the slack in the tubular membranes 266 to pull the tubular membranes 266 straight which keeps the tubular membranes 266 from bending and/or kinking. As the tubular membranes 266 dry and shorten, the tubular membranes 266 pull the outlet header 264 upwardly toward the inlet header 262, for example, due to tension in the tubular membranes 266. In some embodiments, the outlet header 264 may be connected to a flexible conduit, such as a hose or vinyl tubing, that receives working fluid from the outlet header 264 and flexes as the outlet header 264 moves. In another embodiment, the working fluid flows through the outlet header 264 and drains into a basin positioned below the outlet header 264. The outlet header 264 may have an outlet orifice that limits the flow of fluid therethrough (e.g., a small hole, a valve, a pressure regulator) to maintain the pressure in the tubular membrane heat exchanger 260.

The outlet header 264 may be supported by a biasing member such as one or more compression springs 270 positioned below the outlet header 264. While two compression springs are shown, in other forms, one, three or more compression springs may be used. The compression springs 270 may apply an upward force (opposite direction 268) on the outlet header 264 to reduce and counter the downward force applied to the tubular membranes 266 by the weight of the outlet header 264, e.g., the weight of a body 265 of the outlet header 264 and the weight of the fluid in the body 265. For instance, if the outlet header 264 were unsupported, the weight of the outlet header 264 may apply too much force to the tubular membranes 266 which may cause the tubular membranes 266 to tear or become detached from the inlet header 262 and/or outlet header 264. The compression springs 270 may be selected to provide a sufficient force to support a portion of the weight of the outlet header 264 while permitting the outlet header 264 to move in direction 268 as the tubular membranes 266 lengthen. For instance, the length of the springs and spring constant may be selected to provide this balance to permit the outlet header 264 to move while reducing the tensile loading on the tubular membranes 266. The compression springs 270 further provide an upward force opposite direction 268 to aid the tubular membranes 266 in moving the outlet header 264 upward toward the inlet header 262 as the tubular membranes 266 dry and shorten. The compression springs 270 thereby bias the outlet header 264 toward the inlet header 262 which reduces the loading on the tubular membranes 266 and avoids damage to the tubular membranes 266 (e.g., tearing).

The tubular membrane heat exchanger 260 may further include one or more guides 271 that direct the movement of the outlet header 264 as the outlet header 264 moves down and up due to the tubular membranes 266 elongating and shortening. The guides 271 and outlet header 264 form slide connections 273 therebetween that limit the outlet header 264 to linear movement along a vertical axis relative to the inlet header 262. In one embodiment, slide connections 273 include slots of the guides 271 and projections of the outlet header 264 engaged in the slots of the guides 271.

In some embodiments, the outlet headers 264 of multiple tubular membrane heat exchangers 260 are connected together (e.g., via fasteners, interference connections). The connected outlet headers 264 may share a set of springs. For example, where three outlet headers 264 are connected together, springs may be connected to one of the outlet headers to counteract a portion of the weight of the three outlet headers 264 on the associated tubular membranes. The connected outlet headers 264 may similarly share guides 271 or may have their own guides.

In an alternative arrangement, the tubular membrane heat exchanger 260 is oriented horizontally such that the outlet header 264 is movable in directions perpendicular to the direction of gravity for example. As another example, the tubular membrane heat exchanger 260 is oriented obliquely to the vertical such that the outlet header 264 moves along an incline relative to the vertical. In such an arrangement, gravitational forces act on the outlet header in a direction oblique to the direction of movement of the outlet header 264. Where the force of gravity on the outlet header 264 is not great enough to move the outlet header 264 away from the inlet header 262 as the tubular membranes lengthen, the springs 270 may be configured to bias the outlet header 264 away from the inlet header 262 along the guides 271. For example, the springs 270 may include tension, torsion, and/or compression springs to urge the outlet header 264 away from the inlet header 262. The springs 270 may be balanced with the tubular membranes 266 such that as the tubular membranes 266 shorten, the force of the tubular membranes 266 on the outlet header 264 overcomes the force of the springs 270 to move the outlet header 264 toward the inlet header 264 along the guides 271. As yet another example, the tubular membrane heat exchanger 260 may include a first biasing member (e.g., a compression spring) to support a portion or all of the weight of the outlet header 264 and a biasing member (e.g., a tension spring) to bias the outlet header 264 toward or away from the inlet header 262 according to a particular embodiment.

With respect to FIG. 4B, the tubular membrane heat exchanger 260 may include tension springs 272 connected to the outlet header 264 that apply a tensile force to bias the outlet header 264 toward the inlet header 262. For instance, one end of the tension springs 272 may be secured to the inlet header 262 and the other end of the tension springs 272 may be secured to the outlet header 264. While two tension springs are shown, in other forms, one, three or more tension springs may be used. The tension springs 272 apply an upward force opposite gravity acting in direction 268 to reduce the tensile force applied to the tubular membranes 266 by the weight of the outlet header 264 and the weight of the fluid in the outlet header 264. The tension springs 272 may be selected to reduce the force applied to the tubular membranes 266 while permitting the outlet header 264 to move in direction 268 away from the inlet header 262 as the tubular membranes 266 lengthen. For instance, the length of the tension springs 272 and spring constant may be selected to provide this balance to permit the outlet header 264 to move while reducing the strain on the tubular membranes 266. The tension springs 272 further aid the tubular membranes 266 in pulling the outlet header 264 toward the inlet header 262 when the tubular membranes 266 dry and shorten. The tension springs 272 may be in addition to or as an alternative to the compression springs 270.

In an alternative arrangement, the outlet header 264 and inlet header 262 are not vertically aligned. For example, the tubular membrane heat exchanger 260 may be substantially horizontal so that the outlet header 264 moves in directions perpendicular to the direction of gravity. As another example, the tubular membrane heat exchanger 260 obliquely to the vertical such that the outlet header 264 moves along an incline relative to the vertical. In such an arrangement, the direction of gravity is not aligned with the direction 268 of movement of the outlet header 264 relative to the inlet header 262. Where the force of gravity on the outlet header 264 is not great enough to move the outlet header 264 away from the inlet header 262 as the tubular membranes 266 lengthen, the springs 272 may be configured to bias the outlet header 264 away from the inlet header 262 along the guides 271 as the tubular membranes 266 lengthen to take up the slack in the tubular membranes 266. The springs 272 may be balanced with the tubular membranes 266 such that as the tubular membranes 266 shorten, the force of the tubular membranes 266 on the outlet header 264 overcomes the force of the springs 272 to move the outlet header 264 toward the inlet header 264 along the guides 271.

In the embodiment of FIG. 4C, the movable outlet header 264 of the tubular membrane heat exchanger 260 may rest in a fluid 274 in a sump such as fluid basin 275 below the outlet header 264. The fluid 274 may be working fluid of the tubular membrane heat exchanger 260. For example, in one embodiment working fluid flowing through the tubular membrane heat exchanger 260 flows into the fluid basin 275. A portion or the entirety of the movable outlet header 264 may be in the fluid 274. The fluid 274 may apply a buoyant force in direction 276 opposite the direction 268 of gravity. As the tubular membranes 266 lengthen (e.g., when wetted), the tubular membranes 266 lose tension and the weight of the outlet header 264 causes the outlet header 264 to sink farther into the fluid 274. The sinking outlet header 264 keeps the tubular membranes 266 taut until the tubular membranes 266 reach their expanded length and are again placed in tension and support the weight of the outlet header 264 at the lowered depth. As the tubular membranes 266 dry, the tubular membranes 266 experience an increase in tension which shortens the tubular membranes 266 and urges the outlet header 264 toward the inlet header 262. The buoyant force on the outlet header 264 reduces the tensile load on the tubular membranes 266 due to the weight of the outlet header 264 that is suspended by the tubular membranes 266. The fluid 274 may be water as an example. The fluid level in the fluid basin 275 may be maintained at a substantially constant level, for example, by a low head dam or weir 277. In another approach, the embodiment of FIG. 4C may utilize one or more biasing members to control the movement of the outlet header 264.

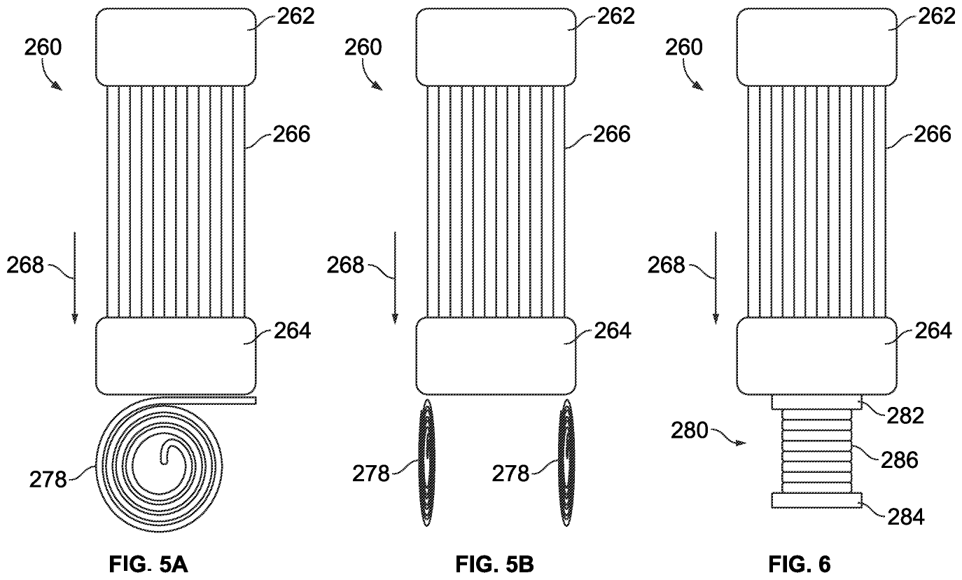

With respect to FIGS. 5A-5B, the tubular membrane heat exchanger 260 includes one or more torsion springs 278 connected to the outlet header 264. The tubular membrane heat exchanger 260 may be arranged vertically with the outlet header 264 suspended from the inlet header 262 by the tubular membranes 266. The inlet header 262 may be fixed while the outlet header 264 is movable relative to the inlet header 262 by gravity in the direction 268 as described above to take up the slack in the tubular membranes 266 as the tubular membranes 266 lengthen. The outlet header 264 may also move opposite direction 268 as the tubular membranes 266 shorten. The torsion springs 278 are connected to the outlet header 264 and provide a spring force that counteracts a portion of the weight of the outlet header 264 which reduces the tensile force applied to the tubular membranes 266 by the weight of the outlet header 264 similar to the tubular membrane heat exchangers 260 of the embodiments of FIG. 4A-4B. While two torsion springs are shown, in other forms, one, three or more torsion springs may be used. The torsion springs may be used in addition to or alternatively to the tension and/or expansion springs described above. Further, other types of biasing members may be used in addition to or as an alternative to the springs described above, such constant force springs, leaf springs, living hinges, and/or resilient beams as some examples.

In an alternative arrangement, where the tubular membrane heat exchanger 260 is oriented horizontally or obliquely to the vertical, the torsion springs 278 may be configured to apply a force to the outlet header 264 to bias the outlet header 264 away from the inlet header 262 as the tubular membranes 266 lengthen to take up the slack in the tubular membranes 266. The torsion springs 278 may be balanced with the tubular membranes 266 such that as the tubular membranes 266 shorten, the tensile force applied by the tubular membranes 266 on the outlet header 264 overcomes the spring force of the torsion springs 278 to draw the outlet header 264 toward the inlet header 262.

With respect to FIG. 6, the tubular membrane heat exchanger 260 includes a deformable or flexible conduit 280 connected to the outlet header 264. The flexible conduit 280 may include a first flange 282, a second flange 284, and a tube portion 286 extending from the first flange 282 to the second flange 284. The first flange 282 of the flexible conduit 280 may be connected to the outlet header 264 so that working fluid may flow from the outlet header 264 and through the flexible conduit 280. In one embodiment, the flexible conduit 280 includes a spring, for example, a spring integrated into the flexible conduit or concentric with the tube portion 286 and extending between the first and second flanges 282, 284. Where the outlet header 264 is vertically aligned with the inlet header 262, the spring may be a compression spring that reduces the force on the tubular membranes 266 from the weight of the outlet header 264 as discussed above. In other forms, for example, where the tubular membrane heat exchanger 260 is oriented transversely to the vertical, the spring may be a tension spring that urges the outlet header 264 away from the inlet header 262 as the tubular membranes 266 lengthen.

In some embodiments, the tube portion 286 of the flexible conduit 280 is made of an elastic or resilient material and the second flange 284 is fixed. As the tubular membranes 266 lengthen, the tube portion 286 of the flexible conduit 280 may apply a resilient force to the outlet header 264 that urges the outlet header 264 away from the inlet header 262 to take up the slack in the tubular membranes 266. The resilient force of the flexible conduit 280 may be balanced with an acceptable tension in the tubular membranes 266 such that as the tubular membranes 266 shorten they overcome the resilient biasing force of the flexible conduit 280 on the outlet header 264 without damaging the flexible conduit 280.

In another embodiment, a cable under tension is attached to the outlet header 264 to pull the outlet header 264 away from the inlet header 262 as the tubular membranes 266 expand. In one form, a portion of the cable may be wound about a drum. The drum may be loaded with a torque that urges the drum to wind the cable up onto the drum. For example, a torsion spring may be connected to the drum to apply the torque to the drum to wind the cable. The torque applied to the drum may be balanced with the tensile force applied by the tubular membranes 266 on the outlet header 264 such that the drum pulls the cable and outlet header 264 when the tubular membranes 266 lengthen and the tubular membranes 266 overcome the force of the cable to draw the outlet header 264 toward the inlet header 262 when the tubular membranes 266 shorten. In some forms, the cable may extend through a pulley system with a counterweight on the opposite end of the cable than the outlet header 264. The weight of the counterweight may be selected to apply a force to the cable to move the outlet header 264 as the tubular membranes lengthen and to permit the tubular membranes 266 to pull the outlet header 264 toward the inlet header 262 as the tubular membranes 266 shorten.

In yet another embodiment, the position of the outlet header 264 is controlled electronically. For example, the tubular membrane heat exchanger 260 motor may include a motor having a shaft that drives a pinion gear. The outlet header 264 may include a rack that the pinion gear engages to drive the outlet header 264 toward or away from the inlet header 262. The tubular membrane heat exchanger 260 may include a controller that monitors the operation of the tubular membrane heat exchanger 260 and adjusts the relative position of the outlet header 264 and inlet header 262 based on the operation of the tubular membrane heat exchanger 260. For example, as the inlet header 262 receives working fluid, such as upon opening of a valve, the controller may cause the motor to increase the distance between the outlet header 264 and inlet header 262 at a rate commensurate with the expected rate of elongation of the tubular membranes 266. As the tubular membranes 266 dry, the controller may operate the motor in a reverse direction to decrease the distance between the outlet header 264 and inlet header 262.

As another example, an electric, pneumatic, or hydraulic actuator may be connected to the outlet header 264 and move the outlet header 264 relative to the inlet header 262. In some approaches, a platform may be connected to and/or support the outlet header 264. The actuator may be connected to the platform and move the platform to adjust the position of the outlet header 264. The actuator may be connected to the platform via a mechanical linkage such as a scissors lift (pantograph) linkage.

As another example, a cable may be attached to the outlet header 264 with a portion thereof wound about a drum. A motor may turn the drum to pull the outlet header 264 via the cable when the tubular membranes 266 are wetted. The motor may turn the drum in the opposite direction to reduce the force on the cable to permit the tubular membranes 266 to urge the outlet header 264 toward the inlet header 262 as the tubular membranes 266 dry.

In various ones of the above approaches, the controller may use a control algorithm to adjust the position of the outlet header 264. The controller may communicate with one or more sensors to determine the movement of the outlet header 264, such as determining a position, velocity, and/acceleration of the outlet header 264 that corresponds to the change in length of the tubular membranes 266. The sensors may indicate, for example, a wetness of the tubular membranes, a driving force of pervaporation of the tubular membranes, and/or the tension in the tubular membranes 266. The controller may also predict the length of the tubes based on the amount of time since the tubular membrane heat exchanger 260 was turned on or off. In some forms, a pneumatic or hydraulic cylinder is used with a constant pressure control, for example, a regulator and a release valve in fluid communication with the cylinder to maintain a constant internal pressure.

While the above examples describe the outlet header 264 being movable, in other embodiments the inlet header 262 is movable according to the approaches described above. For example, the outlet header 264 may be fixed while the inlet header 262 may be moved toward or away from the inlet header 262. As another example, both the outlet header 264 and the inlet header 262 are movable relative to each other. For instance, springs may be connected to each of the outlet header 264 and inlet header 262 and be balanced to permit the distance of the headers 262, 264 to be adjusted to take up the slack in the tubular membranes (or apply a constant force) and to permit the tubular membranes 266 to pull the headers 262, 264 together as the tubular membranes 266 contract.

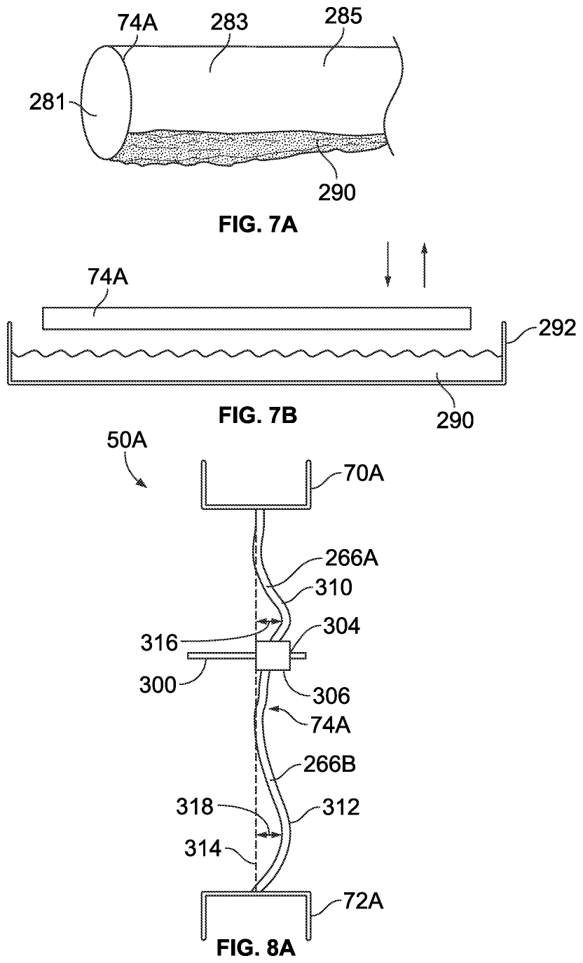

With respect to FIGS. 7A-7B, the tubular membranes 74A of the tubular membrane heat exchanger embodiments discussed above may include a passageway or interior 281, a sidewall 283 extending about the interior 281, and an outer or exterior surface 285 of the sidewall 283. The sidewall 283 is made of a material or materials that facilitate mass and/or heat transfer as discussed above. The tubular membranes 74A of FIGS. 7A and 7B have supporting material 290 bonded to the exterior surface 285 of the sidewall 283 of the tubular membrane 74A. The supporting material 290 may provide support and rigidity for the sidewall 283 to inhibit the sidewall 283 from bending and/or kinking. The supporting material 290 may also limit the expansion of the sidewall 283 as the sidewall 283 swells when wetted. The supporting material 290 may extend along the length of the sidewall 283. For example, the supporting material 290 may extend in a straight line along the length of the sidewall 283. In another approach, the supporting material 290 extends helically about the exterior surface 285 of the sidewall 283. The supporting material may include, as examples, potting, resin, epoxy, urethane, a thermoset such as a light (e.g., ultraviolet light (UV)) cured thermoset, a thermoplastic such as ethylene vinyl acetate, and/or cyanoacrylate that may be mixed with a filler such as glass fiber or calcium carbonate.

In one embodiment, the supporting material sets from a liquid to a solid at a relatively low temperature and will withstand the operating conditions of the tubular membranes 74A. Materials that meet these criteria may include thermosets (epoxies, urethanes, silicones, etc.), thermoplastics that melt at a temperature lower than the melting point of the tubular membranes 74A, adhesive such as cyanoacrylate, a lipid such as wax, a curable ceramic (e.g., cement, silica based ceramic coating, etc.), and/or caulk. Examples of low temperature thermoplastics include polyolefins, ethylene vinyl acetate, and copolymers thereof.

Regarding FIG. 7B, the supporting material 290 may be applied to the tubular membrane 74A by dipping a portion of the sidewall 283 in a bath of the supporting material 290. For example, the supporting material 290 may be disposed in a tray or container 292 in a paste or liquid form. A portion of the sidewall 283 may be dipped into the supporting material 290 in the container 292. The sidewall 283 may be withdrawn from the container 292 with the supporting material 290 bonded to the sidewall 283. The supporting material 290 may be permitted to cure or dry along the sidewall 283. When cured, the supporting material 290 serves as a backbone along the sidewall 283 to resist flexing, bending and/or kinking of the tubular membrane 74A. In some forms, when cured, the supporting material 290 remains flexible and inhibits sharp bending or kinking of the tubular membrane 74A. In some forms, when cured, the supporting material 290 is rigid and keeps the tubular membrane 74A straight.

The sidewall 283 may be dipped in the supporting material 290 when the tubular membrane 74A is dry and in a shortened state. The supporting material 290 may resist or limit the lengthening of the sidewall 283 when the sidewall 283 is wet. In one embodiment, the supporting material 290 may permit controlled lengthening of the sidewall 283 a distance less than the sidewall 283 would lengthen in the absence of the supporting material 290.

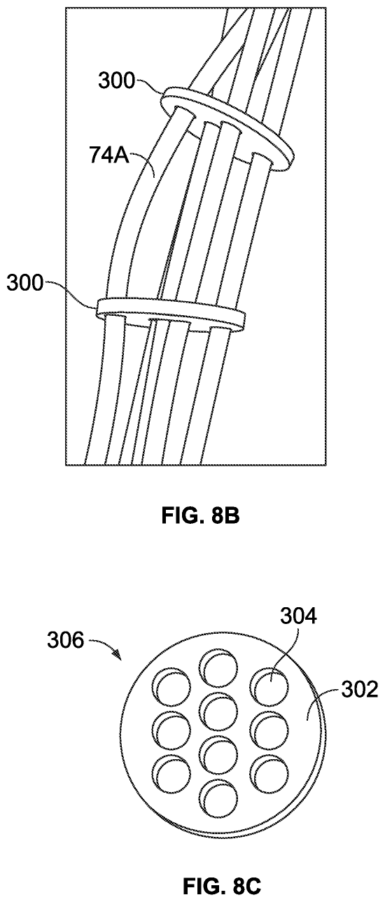

With respect to FIGS. 8A-8C, the tubular membrane heat exchanger 50A may include one or more spacers 300 through which the tubular membranes 74A extend. For example, as shown in FIG. 8B, the tubular membranes 74A extend through two spacers 300 spaced apart from one another along the lengths of the tubular membranes 74A. With respect to FIG. 8C, the spacer 300 may have a body such as plate 302 with openings 304 through which tubular membranes 74A may extend. The spacer 300 may hold the tubular membranes 74A together to resist lateral shifting and bending of the tubular membranes, for example, upon the tubular membranes 74A receiving pressurized fluid. The spacers 300 may also aid to keep the tubular membranes 74A in a generally straight, parallel orientation. The openings 304 of the spacers 300 are spaced apart from one another to form gaps between the tubular membranes 74A to permit fluid (e.g., air) to be passed between the tubular membranes 74A and facilitate heat exchange.

Referring to FIG. 8A, the tubular membrane 74A may be secured to the spacers 300, for example, by potting the tubular membrane 74A to the spacers 300. As shown in FIG. 3A, potting 306 is disposed about the tubular membrane 74A within the opening 304 of the spacer 300 to secure the tubular membrane 74A to the spacer 300. Securing the tubular membrane 74A to the spacer 300 inhibits the tubular membrane 74A from shifting in the opening 304 relative to the spacer 300, for example, as the tubular membrane 74A lengthens as the tubular membrane 74A becomes wet and swells. Thus, the tubular membrane 74A includes a first portion 266A that extends from the inlet header 70A to the spacer 300 and a second portion 266B that extends from the spacer 300 to the outlet header 72A. The first portion 266A, however, is not able to slide through the spacer 300 to add length to the second portion 266B due to the tubular membrane 74A being fixed to the spacer 300 by the potting 306. Inhibiting the tubular membrane 74A from shifting in the spacer opening 304 evenly distributes the increases in length of the tubular membrane 74A on either side of the spacer 300 rather than permitting slack in the tubular membrane 74A to shift below the spacer 300 and form a laterally larger deviation in the shape of the tubular membrane 74A. More specifically, the potting 306 keeps the portions of the tubular membrane 74A in position between two spacers 300 and/or between the spacer 300 and one of the headers 70A, 72A even when the tubular membrane 74 is wetted. This limits the size of bends 310, 312 of the tubular membrane 74A by limiting how far the tubular membrane 74A is able to deviate laterally from a centerline 314 (e.g., a straight line extending between the connections of the tubular membrane 74A to the headers 70A, 72A). For instance, when the tubular membrane 74A lengthens due to being wetted, the first portion 266A is not able to shift through the spacer opening 304 to add length to the second portion 266B and vice versa. The first portion 266A thus forms bend 310 above the spacer 300 and the second portion 266B forms the second bend 312 below the spacer 300. While two bends 310, 312 are formed due to the increasing length of the wetted tubular membrane 74A, because the tubular membrane 74A is secured to the spacer 300 by the potting 306, the lateral distances 316, 318 the bends 310, 312 deviate from centerline 314 are less than they would be if the tubular membrane 74A were able to shift through the spacer opening 304, for example, forming one large bend.

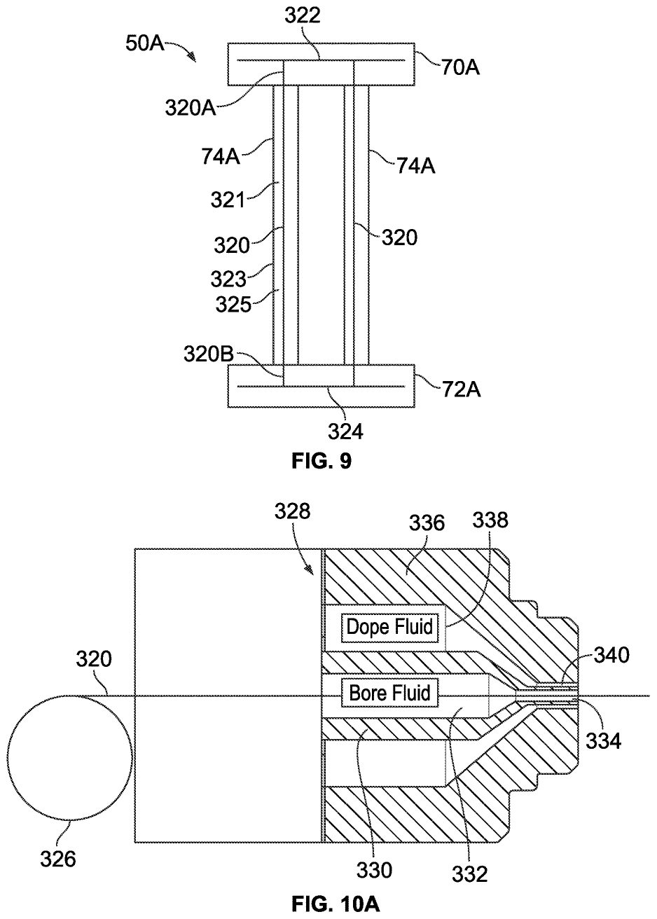

With respect to FIG. 9, the tubular membrane heat exchanger 50A may include tubular membranes 74A having wires 320 extending through the lumen or interior 321 of the tubular membrane 74A. The wires 320 may extend from the inlet header 70A to the outlet header 72A through the tubular membranes 74A to keep the tubular membranes 74A substantially straight and avoid kinking as tubular membranes 74A lengthen and shorten during operation of the tubular membrane heat exchanger 50A. For example, the inlet header 70A may include an inlet support 322 to which a first end portion 320A of the wire 320 is attached and the outlet header 72A may include an outlet support 324 to which a second end portion 320B of the wire 320 is attached. The wire 320 may be drawn taut or substantially straight between the inlet support 322 and outlet support 324. With the wire 320 extending through the tubular membrane 74A, the tubular membrane 74A has a sidewall 323 with an inner surface 325 that contacts the wire 320 if the tubular membrane 74A shifts laterally. The wire 320 thereby limits how far the tubular membrane 74A is able to bend or to deviate from the wire 320, for example, as the tubular membrane 74A lengthens as the tubular membrane 74A is wetted. The wire 320 may also inhibit the tubular membrane 74A from fully closing (e.g., kinking) due to the thickness or diameter of the wire 320 maintaining a spacing between portions of the inner surface 325 across the interior 321 from one another.

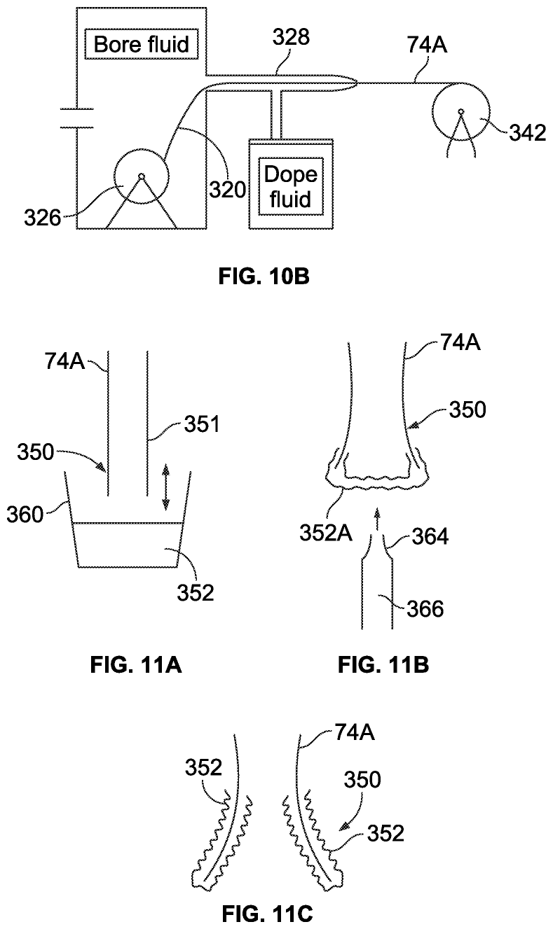

With reference to FIG. 10A-10B, the tubular membrane 74A may be formed about the wire 320. Regarding FIG. 10A, the wire 320 may be paid off from a spool 326 and drawn through a spinneret 328 used to extrude the tubular membrane 74A. The spinneret 328 includes an inner body 330 having an inner cavity 332 and an inner channel 334 extending from the inner cavity 332. The spinneret 328 further includes an outer body 336 having an outer cavity 338 about the inner body 330. An outer channel 340 extends from the outer cavity 338 about the portion of the inner body 330 defining the inner channel 334. Dope fluid is pumped into the outer cavity 338 and along the outer channel 340 while bore fluid is pumped into the inner cavity 332 and along the inner channel 334. The wire 320 extends through the inner cavity 332 and inner channel 334 with the bore fluid. The dope fluid exiting the outer channel 340 cures to form the sidewall of the tubular membrane 74A. The bore fluid exiting the inner channel 334 maintains the cross-sectional shape of the interior of the tubular membrane 74A as the dope fluid cures around the bore fluid to form the tubular membrane 74A. The wire 320 exiting the inner channel 334 is surrounded by the dope fluid exiting the outer channel 340 thus forming the tubular membrane 74A about the wire 320. The dope fluid may be, for example, a copolymer of polyether and polyamide, PP, PDMS, PTFE, polyether block amid (PEBA), or a microporous hydrophobic polysulfone material. The bore fluid may be, for example, compressed air. Although the spinneret 328 is shown in FIG. 10A having a single outer cavity 338 and outer channel 340, the spinneret 328 in other embodiments may include two or more outer cavities and outer channels to form a tubular membrane having a sidewall having two or more layers of material. The materials of the sidewall may be the same or different, such as a dense skin layer and a porous support layer.

With respect to FIG. 10B, the wire 320 may extend from the first spool 326 through the spinneret 328 to a second spool 342. As the dope fluid, bore fluid, and wire are forced through the spinneret 328 to form the tubular membrane 74A, the wire 320 is paid out from the first spool 326. The tubular membrane 74A formed with the wire 320 extending therethrough by the spinneret 328 is wound up on the second spool 342. When a length of the tubular membrane is needed (e.g., for assembling the tubular membrane heat exchanger), a length of the tubular membrane 74A is unwound from the second spool 342 and cut to the desired length. The tubular membrane 74A may then be secured to the inlet and outlet headers 70A, 72A, for example, as shown in FIG. 10A.

As mentioned above, attaching tubular membranes to the headers during assembly is sometimes difficult because the tubular membranes are flexible and relatively flimsy. For example, and with reference to FIG. 1D, to assemble the lower tubular membrane heat exchange module 18B, an end of the tubular membranes 39 may be inserted through openings 42A of the header plate portion 42 of the upper header 41B.

With respect to FIGS. 11A-11C, supporting material 352 may be added to an end portion 350 of the sidewall 351 of the tubular membranes 74A to increase the rigidity of the end portion 350. For example, the end portion 350 may have layers of the supporting material 352 on the interior and exterior surfaces of the end portion 350 to increase the rigidity of the end portion 350. Increasing the rigidity of the end portion 350 of the sidewall 351 limits deformation of the end portion 350 as the end portion 350 is advanced into an opening 42A of the header plate portion 42 (see FIG. 1D) of a header of the tubular membrane heat exchanger. The supporting material 352 may be, as examples, potting, urethane such as water-based urethane, resin, curable ceramic, cyanoacrylate, and/or a thermoset such as an epoxy.

A process for adding the supporting material 352 to the tubular membranes 74A is illustrated in FIGS. 11A-11C. Referring to FIG. 11A, the end portion 350 of the tubular membrane 74A may be dipped into a container 360 including the supporting material 352 in an uncured or liquid form. For example, the supporting material 352 in the container 360 may be a water-based urethane. The end portion 350 of the tubular membrane 74A may then be removed from the supporting material 352 in the container 360. The end portion 350 of the tubular membrane 74A may be covered with the uncured supporting material 352.

With reference to FIG. 11B, the end portion 350 of the tubular membrane 74A may swell when dipped in certain types of supporting material 352, for example, water-based urethane. For example, as shown in FIG. 1B, the wall of the end portion 350 may flare outward such that the end portion 350 has a bell or conical shape. A bubble 352A of the supporting material 352 may form over the opening of the end portion 350 of the tubular membrane 74A. Where the bubble 352A forms, the bubble 352A may be popped to ensure the supporting material 352 does not block the opening of the tubular membrane 74A. An air nozzle 364 connected to an air source (e.g., an air compressor) by a tube 366 may be directed at the bubble 352A. Air may be blown through the air nozzle 364 toward the bubble 352A to cause the bubble 352A to pop and uncover the opening of the end portion 350 of the tubular membrane 74A. In another approach, the bubble 352A may be popped mechanically, for example, by inserting a pin or other object into the bubble 352A.

With reference to FIG. 11C, the supporting material 352 is cured such that the supporting material 352 extends along the sidewall 351 of the end portion 350 of the tubular membrane 74A. For example, the supporting material 352 may cover an interior side and/or exterior side of the sidewall 351 of the end portion 350 of the tubular membrane 74A. The supporting material 352 may be cured by drying the supporting material 352, by applying heat to the supporting material 352, by a chemical reaction occurring within supporting material 352, and/or by the irradiation of supporting material 352, for example, with UV light. The cured supporting material 352 may maintain the shape the end portion 350 of the tubular membrane 74A has upon swelling, for example, the supporting material may hold the end portion 350 in the bell shape. The bell-shaped end portion 350 may be advantageous in inhibiting the end portion 350 from being pulled through an opening of the header. Once the supporting material 352 has cured, the end portion 350 of the tubular membrane 74A is more rigid and less prone to bending or flexing making the end portion 350 easier to handle and/or advance through an opening (e.g., an opening of a header or spacer). The above steps may be repeated to apply multiple layers of the supporting material 352 to the end portion 350 of the tubular membrane 74A to achieve a sufficient rigidity.

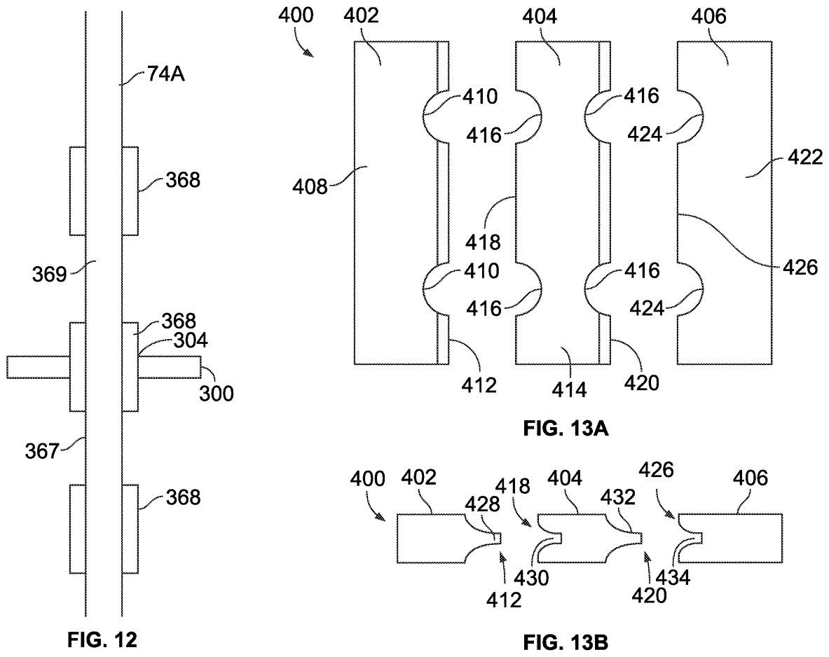

With respect to FIG. 12, the tubular membrane 74A may have supporting material 368 at one or more locations along the length of the tubular membrane 74A. The supporting material 368 increases the strength of the sidewall 367 of the tubular membrane 74A at the portions of the sidewall 367 having supporting material 368 disposed thereon. The supporting material 368 may be a hardening agent such as, for example, resin, potting, and/or a thermoset such as epoxy, urethane, or silicone, a thermoset such as a light (e.g., UV) cured thermoset, a thermoplastic such as ethylene vinyl acetate, and/or cyanoacrylate that may be mixed with a filler such as glass fiber or calcium carbonate. The supporting material 368 may be applied to the sidewall 367 at locations where the sidewall 367 is prone to kinking or being flattened such that flow through the tubular membrane 74A is restricted, for example, where the tubular membrane 74A extends through an opening 304 of the spacer 300. For instance, the supporting material 368 aids to maintain the cross-sectional shape of the sidewall 367 so that the interior 369 of the tubular membrane 74A does not collapse, for example, when the tubular membrane 74A is pressed against the surface of the through hole of the spacer 300 by the lengthening of the tubular membrane 74A. Including supporting material 368 on the tubular membrane 74A also makes it easier to insert the tubular membrane 74A through an opening (e.g., of a spacer or the header plate portion of a header). For instance, an assembly line worker or a robot may securely grip the rigid supporting material 368 when handling the tubular membrane 74A, for example, to insert the tubular membrane 74A through an opening.

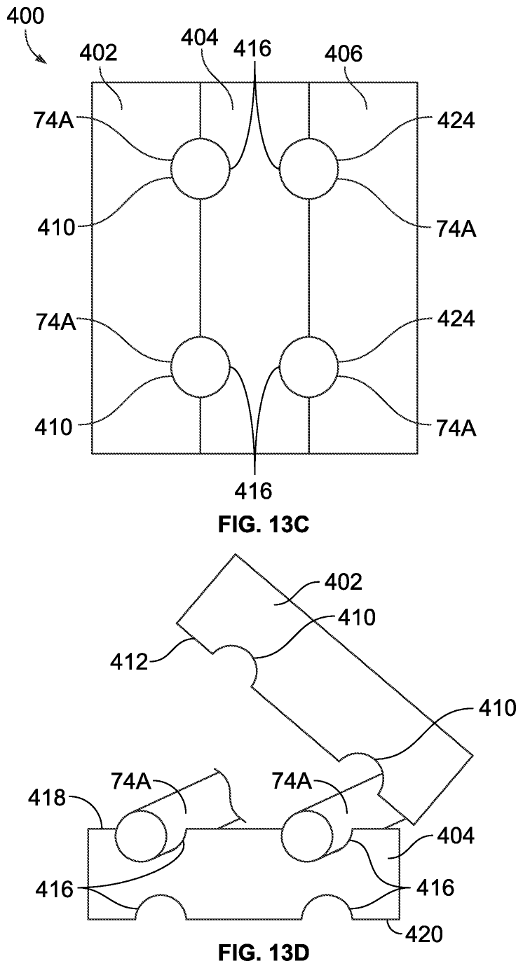

With respect to FIG. 13A-13D, the tubular membrane heat exchanger 50A may include one or more spacer assemblies, such as comb spacers 400, along the length of the tubular membranes 74A between the headers 70A, 72A. The comb spacer 400 is similar in many respects to the spacer 300 in that the spacer 400 may hold the tubular membranes 74A together to resist lateral shifting and bending of the tubular membranes. The spacer 300 and comb spacer 400 may be supported by the tubular membranes 74A and/or supported by a structure, such as a frame secured to one of the inlet and outlet headers. With the comb spacer 400, however, the ends of the tubular membranes do not need to be inserted through openings of the comb spacer 400; instead the comb spacer 400 is assembled about the tubular membranes 74A.

With reference to FIGS. 13A-13B, the comb spacer 400 includes a first spacer portion 402, a middle spacer portion 404, and a second spacer portion 406. The first spacer portion 402, middle spacer portion 404, and second spacer portion 406 may be formed of a plastic, composite, and/or metal material (e.g., a corrosion resistant metal) as some examples. The first spacer portion 402 has a plate portion 408 with two recesses 410 formed along a connecting portion 412. The middle spacer portion 404 has a plate portion 414 with two recesses 416 formed along a first connecting portion 418 and two recesses 416 formed along a second connecting portion 420. The second spacer portion 406 has a plate portion 422 with two recesses 424 formed along a connecting portion 426. The recesses 410, 416, 424 of the first spacer portion 402, middle spacer portion 404, and second spacer portion 406 may be, as examples, semi-circular, semi-ovular, and/or rectangular and sized to receive at least a portion of a tubular membrane 74A.

The connecting portion 412 of the first spacer portion 402 interlocks with the first connecting portion 418 of the middle spacer portion 404. The connecting portion 412 of the first spacer portion 402 may have a male end profile with a snap protrusion 428 and the first connecting portion 418 of the middle spacer portion 404 may have a female end profile with a recess 430. The snap protrusion 428 may be inserted into the recess 430 to connect the first spacer portion 402 to the middle spacer portion 404 by a snap fit connection. The second connecting portion 420 of the middle spacer portion 404 interlocks with the connecting portion 426 of the second spacer portion 406. The second connecting portion 420 of the middle spacer portion 404 may have a male end profile with a snap protrusion 432 and the connecting portion 426 of the second spacer portion 406 may have a female end profile with a recess 434. The snap protrusion 432 may be inserted into the recess 434 to connect the middle spacer portion 404 to the second spacer portion 406 by a snap fit connection.

The comb spacer 400 may be assembled about the tubular membranes 74A by connecting the first spacer portion 402, middle spacer portion 404, and second spacer portion 406 (see FIG. 13C). With reference to FIG. 13D, to assemble the comb spacer 400 about the tubular membranes 74A, tubular membranes 74A may be positioned in the recesses 416 of the middle spacer portion 404. The recesses 410 of the first spacer portion 402 may be aligned with the recesses 416 of the middle spacer portion 404. The first spacer portion 402 may be snapped to the middle spacer portion 404 along the connecting portions 412, 418 as described above. The aligned recesses 410, 416 of the first spacer portion 402 and middle spacer portion 404 form openings about the tubular membranes 74A. The second spacer portion 406 may similarly be snapped to the middle spacer portion 404 with tubular membranes 74A positioned in the aligned recesses 416, 424 of the second spacer portion 406 and the middle spacer portion 404 to form the assembled comb spacer of FIG. 13C.

While the comb spacer 400 described above receives four tubular membranes 74A, the comb spacer 400 may be configured to support any number of tubular membranes. For example, the first spacer portion 402, middle spacer portion 404, and second spacer portion 406 may have three, four, or more recesses to receive and support the tubular membranes 74A. Additionally or alternatively, the comb spacer 400 may include two, three, or more middle spacer portions 404 between the first and second spacer portions 402, 406 to support additional tubular membranes 74A. The comb spacer 400 thereby allows the comb spacer 400 to be assembled about the tubular membranes 74A instead of inserting tubular membranes 74A through openings of the spacer which, as explained above, may be difficult given the flexible and flimsy behavior of the tubular membranes 74A.

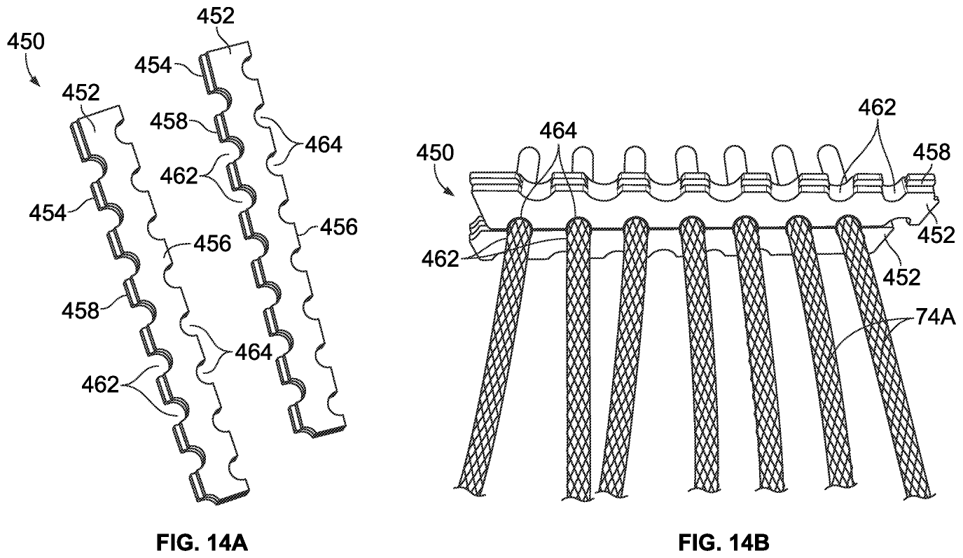

With respect to FIG. 14A-14B, a comb spacer 450 is provided according to another embodiment. The comb spacer 450 is similar to the comb spacer 400 described with respect to FIGS. 13A-13D such that the differences will be highlighted. The comb spacer 450 is assembled from two or more spacer bodies 452. The spacer bodies 452 may be identical to one another such that a plurality of the same spacer bodies 452 may be connected to form the comb spacer 450 having the desired quantity of openings for the tubular membranes. In other forms, the comb spacer 450 may include end spacer portions similar to those described with respect to FIGS. 13A-13D. The spacer bodies 452 include a first connecting portion 454 and a second connecting portion 456. The first connecting portion 454 may have a male profile with a snap protrusion 458. The second connecting portion 456 may have a female profile with a recess for receiving the snap protrusion 458 of another spacer body 452 to connect the comb spacers 450 together (see FIG. 14B). The first connecting portion 454 of the spacer body 452 includes recesses 462 for receiving a portion of a tubular membrane 74A. The second connecting portion 456 of the spacer body 452 may also have recesses 464 for receiving a portion of a tubular membrane 74A. The recesses 464 of the second connecting portion 456 may be shifted along the length of the spacer body 452 relative to the recesses 462 of the first connecting portion 454. For example, the recesses 464 of the second connecting portion 456 are aligned with the gap between the recesses 462 of the first connecting portion 454. The assembled comb spacer 450 may thus holds the rows of the tubular membranes 74A out of alignment with one another which, for example, may provide a more tortuous flow path for fluid flowing through the tubular membranes 74A.

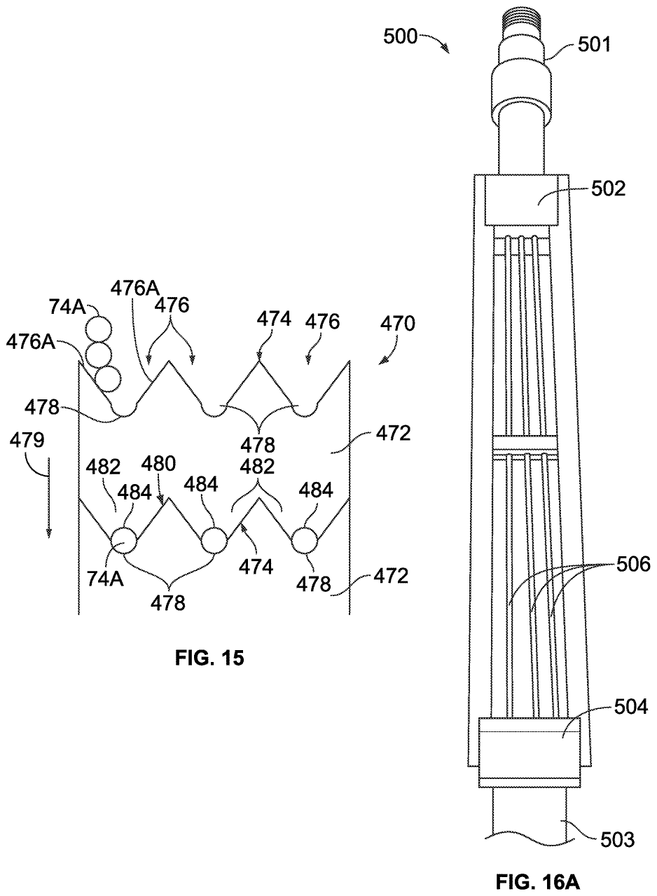

With respect to FIG. 15, a comb spacer 470 is provided according to another embodiment. The comb spacer 470 is similar to the comb spacer embodiments described above such that the differences will be highlighted. The comb spacer 470 includes spacer bodies 472 that may be connected together about the tubular membranes 74A as described above. The spacer bodies 472 include a first connecting portion 474 that includes one or more recessed portions 476 and a recess 478 at an innermost point of the recessed portion 476. The recessed portion 476 include guide edges 476A extending outward from the recesses 478 (e.g., in a V-shape) to guide a tubular membrane 74A into the recesses 478. For example, when direction 479 is the direction of gravity and tubular membranes 74A are set in the recessed portions 476, the guide edges 476A direct the tubular membranes 74A into the associated recesses 478. In this manner, the guide edges 476A assist in positioning the tubular membranes in the spacer body 452.

The spacer bodies 472 include a second connecting portion 480 for connection to the first connecting portion 474 of another spacer body 472. The second connecting portion 480 includes one or more protruding portions 482 that may be inserted into the recessed portions 476 of the first connecting portion 474 of another comb spacer body 472. The protruding portions 482 include a recess 484 at an end portion thereof that aligns with the recess 478 of the recessed portion 476 of another spacer body 472 when the protruding portion 482 is received in the recessed portion 476. The first connecting portion 474 of a first spacer body 472 may be connected to the second connecting portion 480 of a second spacer body 472 with tubular membranes 74A positioned in the recesses 478 of the first spacer body 472 to secure the tubular membranes 74A with the first and second spacer bodies 472.

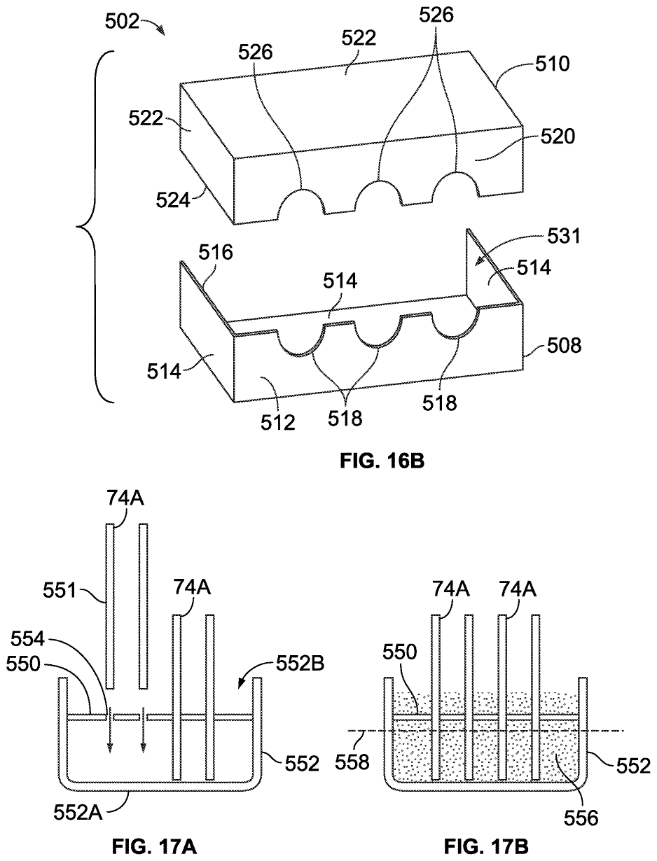

With respect to FIG. 16A, a tubular membrane heat exchanger 500 is provided according to another embodiment. The tubular membrane heat exchanger 500 is similar in many respects to the tubular membrane heat exchanger embodiments discussed above such that the differences will be highlighted. The tubular membrane heat exchanger 500 has an inlet 501, an inlet header 502, an outlet header 504, an outlet 503, and tubular membranes 506 extending between the inlet header 502 and the outlet header 504. The headers 502, 504 may each have a comb configuration for attaching to the tubular membranes 506 similar in many respects to the comb spacers described above. In some embodiments, the headers 502, 504 may have a comb similar in many respects to the comb spacers described above where the combs receive fittings of the tubular membranes 506, such as fitting 204 in FIG. 1E, instead of tubular membranes 506.

With respect to FIG. 16B, the inlet header 502 includes first body such as first header portion 508 and a second body such as second header portion 510 that may be joined together to form the inlet header 502 about the tubular membranes 506. While the following discussion relates to the inlet header 502, the outlet header 504 may be similar to the inlet header 502. The first header portion 508 and second header portion 510 may be formed of a plastic, composite, and/or metal material (e.g., a corrosion resistant metal). The first header portion 508 includes a header plate 512 and sidewalls 514 extending from the header plate 512. In some forms, the header plate 512 is a separate piece from the sidewalls 514 and is connected to the sidewalls 514, for example, with potting. The first header portion 508 includes a connecting portion 516 that interfaces with the second header portion 510 to connect the first header portion 508 to the second header portion 510. The header plate 512 includes recesses 518 along the connecting portion 516 for receiving a portion of the tubular membranes 506. The second header portion 510 likewise includes a header plate 520 and sidewalls 522 extending from the header plate 512. In some forms, the header plate 520 is a separate piece from the sidewalls 522 that is connected to the sidewalls 522, for example, with potting. The second header portion 510 includes a connecting portion 524 with recesses 526 along the connecting portion 524 that align with the recesses 518 of the first header portion 508. The first and second header portions 508, 510 may be connected together along the connecting portions 516, 524, for example, a snap fit connection as described above with respect to the comb spacers. The tubular membranes 506 may be positioned in the recesses 518, 526 as the first header portion 508 and second header portion 510 are connected.

The number of recesses 518, 526 the inlet header 502 may be selected to receive a selected number of tubular membranes 506. In one embodiment, the inlet header 502 may also include one or more center header portions positioned between the between the first and second header portions 508, 510, for example, similar to middle spacer portion 404 of the comb spacer 400 discussed above.

Once the inlet header 502 has been assembled with the tubular membranes 506 (and/or fittings 204), the inlet header 502 has a compartment 531 formed by the sidewalls 514, 522 and header plates 512, 520. Potting may be disposed in the compartment 531 to secure the first header portion 508 to the second header portion 510 and to secure the tubular membranes 506 to the inlet header 502. The outlet header 504 may similarly be assembled and secured to the tubular membranes 506. In embodiments where the header plates 512, 520 are separate from the sidewalls 514, 522, the header plates 512, 520 may be assembled with the tubular membranes 506 (or fittings 204) similar to the comb plates described above. The sidewalls 514, 522 may be attached to the header plates 512, 520. For example, potting may be disposed in the compartment 531 to secure the header plates 512, 520 together and to secure the sidewalls 514, 522 to the header plates 512, 520.

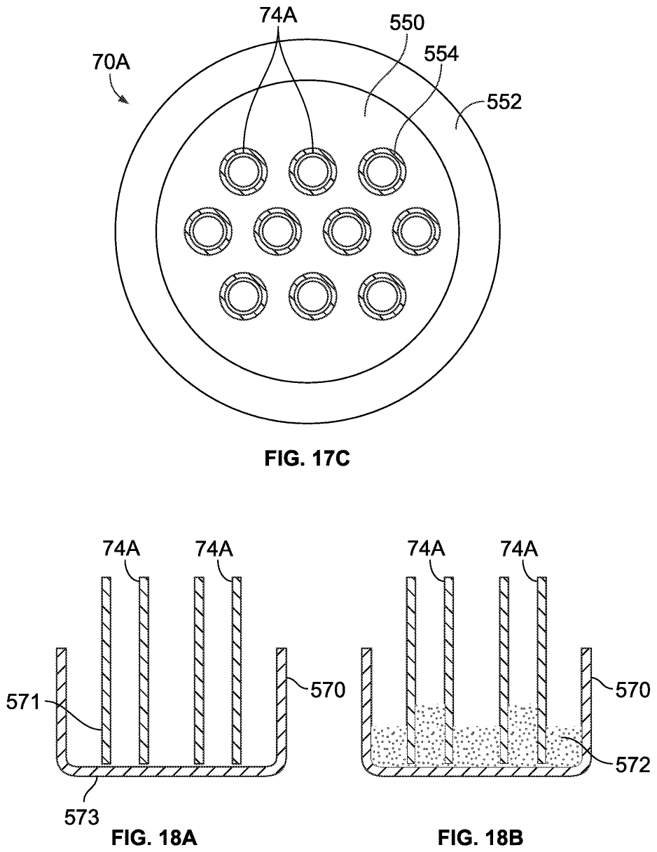

With respect to FIGS. 17A-17C, the inlet and outlet headers 70A, 72A of the tubular membrane heat exchanger 50A may be formed by molding the header over a spacer 550 and the end portions of the tubular membranes 74A. The spacer 550 operates as a header plate that maintains end portions 551 of the tubular membranes 74A in fixed positions relative to one another. Regarding FIG. 17A, the spacer 550 may be placed in a mold, such as a container 552. End portions 551 of the tubular membranes 74A may be inserted into the container 552 through openings 554 in the spacer 550. Regarding FIG. 17B, potting 556 may be distributed into the container 552 to cover the spacer 550 and the end portions of the tubular membranes 74A inserted into the container 552. The potting 556 may be, as examples, a resin such as epoxy, urethane, or silicone, and/or a thermoset with added fillers such as quartz, limestone, glass fiber, and/or calcium carbonate. The potting 556 may have a low cure rate to inhibit overheating and shrinking. As an example, the potting 556 may be an epoxy with a cure time between 12 and 48 hours. As another example, the potting 556 may be a two part epoxy with a cure time of 24 hours produced by the mixture of a hardener and a resin.

The spacer 550 maintains the relative position of the tubular membranes 74A as the potting 556 is distributed into the container 552. The spacer 550 may also aid to hold straight the end portions 551 of the tubular membranes 74A extending through the spacer 550. The container 552 may include a ledge or protrusion(s) that the spacer 550 rests on to support the spacer 550 above a base 552A of the container 552. In another form, the spacer 550 is held in place within the container 552 by friction. For example, walls of the container 552 may taper inward from an opening 552B of the container 552 to the base 552A. The spacer 550 may be sized to be inserted partially into the container 552 and be supported above the base 552A by resting on the tapered walls. In another approach, the spacer 550 is supported above the base 552A by buoyancy as the potting 556 fills container 552 below the spacer 500. In another approach, the spacer 550 is supported above the base 552A (e.g., suspended by string) such that the spacer 550 is not covered with the potting 556. The potting 556 may be advanced into the container 552 below the spacer 550 while the spacer 550 holds the end portions 551 of the tubular membranes 74A straight and spaced apart from one another.

The potting is cured to harden the potting about the tubular membranes 74A and spacer 550. The potting 556 and the container 552 may be cut along line 558 close to or along the spacer 550 to form the header 70A (see FIG. 17C). The potting 556 may be cut close to the spacer 550 where the relative positioning of the tubular membranes 74A is fixed by the openings 554 of the spacer 550 and where the tubular membranes 74A extend substantially parallel to one another as they extend through the spacer 550. In some approaches, the cured potting 556, spacer 550, and tubular membranes 74A are removed from the container 552 before cutting the potting 556 along line 558 to form the header 70A. The outlet header 72A may similarly be formed on the opposite end of the tubular membranes 74A.

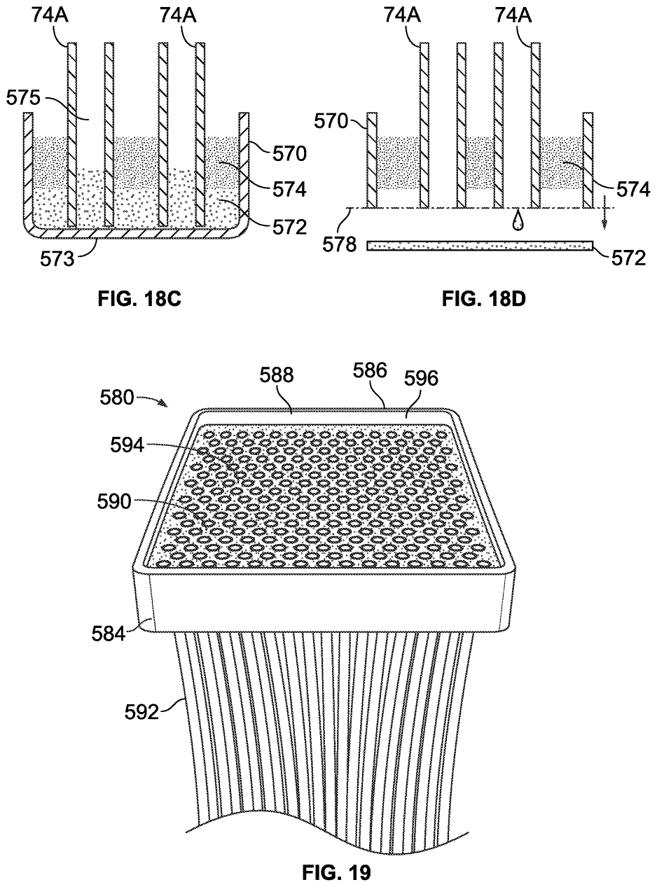

With respect to FIGS. 18A-18D, a process for forming the headers 70A, 72A is provided where the potting material (e.g., resin) molded to form the headers 70A, 72A is not cut. Regarding FIG. 18A, one or more tubular membranes 74A may be inserted into a container 570. For example, end portions 571 of the tubular membranes 74A may be lowered into the container 570 with the tubular membranes 74A positioned slightly above a base portion 573 of the container 570 such that there is a gap spacing between the tubular membrane end portions 571 and the container base portion 573. Regarding FIG. 18B, a filler material such as a wax material 572 is advanced (e.g., poured) into the container 570. Some of the wax material 572 may be drawn up the end portions 571 of the tubular membranes 74A by capillary action and plug the tubular membranes 74A. In another approach, a heat source, such as a hot plate, is positioned below the container 570 to keep the wax 572 in its molten form and allowing the wax 572 to level. Once the layer of wax 572 is sufficiently level, the heat source may be removed or turned off to allow the wax 572 to solidify.

Regarding FIG. 18C, once the wax material has solidified, a potting material 574 may be distributed into the container 570 over the layer of the wax 572. The wax material 572 blocks the potting material 574 from entering interiors 575 of the tubular membranes 74A. The potting material 574 may be similar to the potting materials described above, for example, a thermoset resin such as epoxy, urethane, or silicone. The wax 572 may be a type of wax that has a sufficiently high melting temperature such that the wax 572 does not melt when the potting material 574 is distributed over the layer of wax 572 (if the potting material 574 is heated or if the potting material produces heat as it cures). The wax 572 may include, as examples, paraffin, beeswax, or water-soluble wax. As an example, water-soluble wax may be polyethylene glycol wax. As another example, water-soluble wax may be a mixture of polyethylene glycol wax and one or more of a filler or an effervescing agent. As examples, the filler may be calcium carbonate and/or the effervescing agent may be sodium bicarbonate.

Regarding FIG. 18D, once the potting material 574 has cured, the base portion 573 of the container 570 may be removed (e.g., cut off from the rest of the container 570) and heat is applied to melt the wax 572 from the potting material 574. In some embodiments, the base portion 573 is attached to the walls of the container 570 by a weak adhesive and may be removed by peeling the base portion 573 from remainder of the container 570. For example, the base portion 573 may be made of adhesive tape. Melting the wax 572 causes the wax 572 within the tubular membranes 74A to melt away to reopen or unplug the end portions 571 of the tubular membranes 74A. In another approach, the wax 572 is water-soluble and the assembly of the potting material 574, tubular membranes 74A, and wax 572 are placed in a water bath to remove the wax. In another approach, the working fluid of the tubular membrane heat exchanger 50A dissolves the wax 572 when the heat exchanger is first used. In another approach, solvents other than water may alternatively or additionally be used to dissolve the wax 572, for example, an organic non-polar solvent such as methyl ethyl ketone.

The container 570 and tubular membranes 74A may be cut along line 578 close to or along the layer of potting material 574 to form the header 70A. In another approach, the wax 572 and potting material 574 layers are removed from the container 570 before the wax 572 is melted from the potting material 574. The end portions 571 of the tubular membranes 74A extending through the potting material 574 may then be trimmed to form the header 70A. A second layer of resin may be applied to fill in any holes in the potting material 574 left behind upon removing the wax 572. For example, the wax 572 may be present on surfaces portions of the tubular membranes 74A and/or container 570 that are intended to be contacted by the potting material 574 which leaves gaps between the potting material 574 and surface portions when the wax 572 is melted away. The outlet header 72A may similarly be formed on the opposite end of the tubular membranes 74A.

With reference to FIG. 19, a header 580 is shown that was produced using a process similar to the process of FIGS. 18A-18D. The header 580 includes a body 584 having sidewalls 586 that form an opening 588. The header 580 has a header plate 590 formed by potting that was poured over wax previously applied to the ends of tubular membranes 592 (see, e.g., FIG. 18C). The header plate 590 has an inner surface 594 that is contacted by the working fluid that travels through the tubular membranes 592. The header 582 has a compartment 596 that was formed by removing the wax on the ends of the tubular membranes 592 (see, e.g., 18D). The header 580 is joined to another header component (e.g., a distribution header similar to the distribution header 16C of FIG. 1C) to enclose the compartment 596. If the header 580 is implemented as an inlet header, the working fluid enters the compartment 596 and travels into the tubular membranes 592. If the header 580 is implemented as an outlet header, the working fluid travels from the tubular membranes 592 into the compartment 596.

In another embodiment, the headers 70A, 72A may be formed without the use of wax. The tubular membranes 74A may be lowered into the container 570 as shown in FIG. 18A. Resin may be distributed into the container 570 to form a first resin layer (e. g,, in place of the wax in FIG. 18B). Some of the resin may be drawn into the end portions 571 of the tubular membranes 74A, for example, by capillary action. Once the first layer of resin is cured, a second layer of resin may be distributed over the first layer of resin (similar to FIG. 18C). The first layer of resin plugs the ends of the tubular membranes 74A and inhibits the resin of the second layer of resin from entering the tubular membranes 74A. Once the second layer of resin is cured, the resin may be cut at or above the interface of the first layer of resin and the second layer of resin. Cutting above the first layer of resin ensures that when the tubular membranes 74A are cut, the tubular membranes 74A are cut above any resin that may have been drawn into and plug the tubular membrane 74A. In other words, cutting above the first layer of resin ensures that the tubular membranes 74A of the header 70A are not plugged with resin.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B. While there have been illustrated and described particular embodiments of the present invention, it will be appreciated that numerous changes and modifications will occur to those skilled in the art, and it is intended for the present invention to cover all those changes and modifications which fall within the scope of the appended claims. For example, the tubular membrane apparatuses discussed herein may be utilized for dehumidification, air pollutant (e.g., carbon) capture systems, and other applications.

1. A tubular membrane apparatus comprising:
an inlet header to receive a first fluid;
an outlet header;
a plurality of elongate tubular membranes having interiors that permit the first fluid to flow from the inlet header to the outlet header;
sidewalls of the tubular membranes extending about the interiors, the sidewalls configured to facilitate heat transfer and/or mass transfer between a second fluid contacting exterior surfaces of the sidewalls of the tubular membranes and the first fluid in the interiors of the tubular membranes;
the tubular membranes configured to lengthen in response to the interiors of the tubular membranes receiving the first fluid;
the inlet header and the outlet header are movable relative to one another to increase a distance between the inlet header and the outlet header and compensate for the lengthening of the tubular membranes.

2. The tubular membrane apparatus of claim 1 wherein the tubular membranes are configured to shorten in response to an absence of the first fluid in the interiors of the tubular membranes; and
wherein the inlet header and the outlet header are movable relative to one another to decrease the distance between the inlet header and the outlet header and compensate for shortening of the tubular membranes.

3. The tubular membrane apparatus of claim 1 wherein one of the inlet header and the outlet header is configured to shift away from the other of the inlet header and the outlet header due to the effect of gravity on the one of the inlet header and the outlet header and the lengthening of the tubular membranes.

4. The tubular membrane apparatus of claim 1 further comprising a guide and a slide connection between the guide and one of the inlet header and the outlet header, the slide connection facilitating movement of the one of the inlet header and the outlet header away from the other of the inlet header and the outlet header to increase the distance between the inlet header and the outlet header.

5. The tubular membrane apparatus of claim 4 wherein the other of the inlet header and the outlet header is configured to be stationary as the one of the inlet header and the outlet header moves away from the other of the inlet header and the outlet header.

6. The tubular membrane apparatus of claim 1 further comprising a biasing member to bias the inlet header and the outlet header apart or toward one another.

7. The tubular membrane apparatus of claim 1 further comprising a biasing member connected to one of the inlet header and the outlet header to bias the one of the inlet header and outlet header away from the other of the inlet header and the outlet header.

8. The tubular membrane apparatus of claim 1 further comprising a guide and a slide connection between the guide and one of the inlet header and the outlet header, the slide connection configured to permit movement of the one of the inlet header and the outlet header away from the other of the inlet header and the outlet header to increase the distance between the inlet header and the outlet header; and
a spring configured to resiliently bias the one of the inlet header and the outlet header either toward or away from the other of the inlet header and the outlet header.

9. The tubular membrane apparatus of claim 8 wherein the slide connection permits the one of the inlet header and the outlet header to shift away from the other of the inlet header and the outlet header under the effect of gravity; and
wherein the spring comprises one or more springs that bias the one of the inlet header and the outlet header toward the other of the inlet header and the outlet header.

10. The tubular membrane apparatus of claim 1 wherein at least one of the inlet header and the outlet header are movable to increase the distance between the inlet header and the outlet header, the tubular membrane apparatus further comprising:
a flexible conduit for the first fluid connected to the at least one of the inlet header and the outlet header.

11. The tubular membrane apparatus of claim 1 further comprising a sump to receive the first fluid;
wherein one of the inlet header and the outlet header is configured to be in the first fluid in the sump, the one of the inlet header and the outlet header moving deeper in the first fluid as the distance between the inlet header and the outlet header increases.

12. The tubular membrane apparatus of claim 1 wherein the first fluid is a working fluid and the second fluid is air.

13. The tubular membrane apparatus of claim 12 further comprising a fan assembly operable to cause the air to contact the exterior surfaces of the tubular membranes.

14. A method of assembling a tubular membrane apparatus, the method comprising:
wetting tubular membranes to cause the tubular membranes to elongate, the tubular membranes each having a first end portion secured to an inlet header and a second end portion secured to an outlet header;
moving the inlet header and outlet header relative to one another to increase a distance therebetween from a first distance to a second distance to take up slack in the elongated tubular membranes; and
fixing the inlet header and outlet header relative to one another so that the inlet header and the outlet header have the second distance therebetween.

15. The method of claim 14 further comprising drying the tubular membranes while maintaining the second distance between the inlet header and the outlet header.

16. The method of claim 15 wherein drying the tubular membranes increases a tension in the tubular membranes.

17. The method of claim 14 wherein the elongated tubular membranes have a first tension upon fixing the inlet header and the outlet header relative to one another, the method further comprising:
drying tubular membranes which causes the tubular membranes to have a second tension greater than the first tension.

18. The method of claim 14 further comprising drying the tubular membranes and causing the tubular membranes to tauten.

19. The method of claim 14 wherein moving the inlet header and outlet header relative to one another includes increasing the distance between the inlet header and outlet header until the tubular membranes are spaced apart from one another to reduce contact between the tubular membranes.

20. The method of claim 14 further comprising:
securing first end portions of the tubular membranes to the inlet header; and
securing second end portions of the tubular membranes to the outlet header.

21. The method of claim 20 wherein securing the first end portions of the tubular membranes to the inlet header includes applying first potting to the first end portions of the tubular membranes and an inlet header body of the inlet header; and
wherein securing the second end portions of the tubular membranes to the outlet header includes applying second potting to the second end portions of the tubular membranes and an outlet header body of the outlet header.

22. The method of claim 14 further comprising installing the inlet header and outlet header in a heat exchanger unit while the inlet header and the outlet header have the second distance therebetween.

23-37. (canceled)
